(19) United States
(12) Patent Application Publication
(10) Pub. No.: US 2005/0052686 A1
(43) Pub. Date: Mar. 10, 2005

(54) Image outputting system

(75) Inventor: Hiroyuki Maruyama, Tokyo (JP)

Correspondence Address: Finnegan, Henderson, Farrabow;Garrett & Dunner, L.L.P., 1300 I Street, N.W., Washington, DC, 20005-3315, US

(73) Assignee: KONICA MINOLTA BUSINESS TECHNOLOGIES, INC.

(21) Appl. No.: 10/852,451

(22) Filed: May 25, 2004

(30) Foreign Application Priority Data
Aug. 20, 2003 (JP) 2003-296421
Nov. 5, 2003 (JP) 2003-375066
Apr. 5, 2004 (JP) 2004-111137

(51) Int. Cl. G06F 15/00; H04N 7/00

(52) U.S. Cl. 358/1.15

(57) ABSTRACT

An image outputting system has: a plurality of network terminals; an image forming device for forming an image based on an image forming instruction transmitted from the network terminals, the image forming device being connected to the network terminals through a network; and a transmitting device for wirelessly transmitting ID information thereof, wherein the image forming device includes: a receiving section for receiving record data from the network terminals, the record data including record data to which ID information corresponding to the ID information of the transmitting device is added; a storing section for storing the record data; a wireless receiving section for wirelessly receiving the ID information from the transmitting device; and a controlling section for controlling the image forming device to output the record data to which the ID information is added if the added ID information corresponds to the received ID information.

### BACKGROUND OF THE INVENTION

1. Field of the Invention

The invention relates to an image outputting system. In particular, the invention relates to an image outputting system with improved security of outputted document.

2. Description of Related Art

Conventionally, an image forming device of an electronic photography type is well known, the image forming device performing image formation (printing) by irradiating light to a photosensitive layer which is electrified uniformly for exposure to form a latent image, developing the latent image by making toner adhere on the photosensitive layer, and transferring the developed image to paper.

As the image forming device, a digital photocopier or the like is well known, the digital photocopier or the like comprising an image reading section for reading an image from document on which the image is recorded and for outputting the read image as image data, and an image forming section for forming an image on paper or the like based on the image data. Further, the image forming device may be a printer or the like comprising only the image forming section.

Further, in general, a system comprising plural PCs (Personal Computer) and one or plural network image forming device(s) such as a printer, a photocopier with a printer function (MFP: Multi-Function Printer) or the like being connected to the plural PCs, is built so as to enable plural users to share the one or plural image forming device(s). In such a system, since the plural users use one image forming device, when important document is to be outputted as a print, the output can be done after the user transmits the printing instruction from the PC to the image forming device until the user travels to an installation location of the image forming device. Therefore, there is a possibility of exposing the document to someone else or a possibility of mixing the document with others.

In particular, if there is a large distance between the PC which the user operates to input the printing instruction and the image forming device performing the printing, it takes a user some time to travel to pick up a document to which the user has instructed the printing. Thereby, there is a possibility of mistakenly picking the document up by someone else, or a possibility of exposing the printed contents to someone else although it is not supposed to.

Based on the foregoing problem, proposed is a network management system using fingerprint authorization, comprising fingerprint information extracting section and outputting a document after identifying a user with the use of extracted fingerprint information (for example, see Japanese Patent Application Publication (Unexamined) No. Tokukai 2001-265739). Since the user is not allowed to use the image formation device until directly touching the fingerprint information extracting section, the system has a structure in which no one can print and receive the document except for the user having instructed the printing.

However, even in the above-mentioned conventional art, since the document is not outputted until a user who has instructed the printing of the document travels to the installation location of the image forming device and has himself identified with the use of fingerprint information, there is a problem that the user has to wait beside the image forming device for the document to be outputted.

In particular, if the image forming device is in a sleep state, it takes awhile to have the device to be back from the sleep state, and further if an operation to correct an image forming condition such as an image quality correcting operation is to be performed before the image forming operation, the user has to wait for even longer time period.

### SUMMARY OF THE INVENTION

The present invention was made in view of the problems of the above-mentioned conventional art, and an object thereof is to provide an image outputting system capable of improving security at the time of outputting a document.

In accordance with a first aspect of the present invention, an image outputting system comprises: a plurality of network terminals; an image forming device for forming an image based on an image forming instruction transmitted from the plurality of network terminals, the image forming device being connected to the plurality of network terminals through a network; and a transmitting device for wirelessly transmitting ID information thereof, wherein the image forming device comprises: a receiving section for receiving record data from the plurality of network terminals, the record data including record data to which ID information corresponding to the ID information of the transmitting device is added; a storing section for storing the record data; a wireless receiving section for wirelessly receiving the ID information from the transmitting device; and a controlling section for controlling the image forming device to output the record data to which the ID information is added if the ID information added to the record data corresponds to the ID information received from the transmitting device.

According to the system of the first aspect, record data to which ID information is added is outputted if ID information added to the record data corresponds to ID information received from the transmitting device. Thereby, it is possible to improve the security without having a user wait.

Preferably, in the system of the first aspect of the present invention, when the receiving section receives the record data to which ID information is not added, the controlling section controls the image forming device to sequentially output the record data to which ID information is not added.

According to the above-mentioned system, since record data to which ID information is not added is sequentially outputted, it is possible to output a document having low confidentiality without having a condition.

Preferably, in the system of the first aspect of the present invention, when the wireless receiving section receives a plurality of pieces of ID information, the controlling section controls the image forming device to stop an output of the record data to which the ID information is added and to display information indicating that the output is stopped.

According to the above-mentioned system, if a plurality of pieces of ID information are received, since the output of record data to which ID information is added is stopped, it is possible to prevent others from obtaining the outputted document.

Preferably, in the system of the first aspect of the present invention, when the ID information added to the record data corresponds to the ID information received from the transmitting device and there is a job currently being outputted, the controlling section controls the image forming device to output the record data to which the ID information is added after an output of the job is completed.

According to the above-mentioned system, if ID information added to the record data corresponds to ID information received from the transmitting device, when there is a job being outputted, the record data to which ID information is added is outputted after the output of the job is completed. Thereby, it is possible to output the record data to which ID information is added by interrupting other jobs which are scheduled to be outputted after the job being outputted. Therefore, it is possible to reduce the waiting time of a user.

Preferably, in the system of the first aspect of the present invention, when the ID information added to the record data corresponds to the ID information received from the transmitting device and there is a job currently being outputted, the controlling section controls the image forming device to stop an output of the job, to output the record data to which the ID information is added, and to resume the output of the job after an output of the record data to which the ID information is added is completed.

According to the above-mentioned system, if ID information added to the record data corresponds to ID information received from the transmitting device, when there is a job being outputted, the job being outputted is stopped. Thereby, it is possible to output the record data to which ID information is added without having a user wait.

Preferably, in the system of the first aspect of the present invention, the image forming device comprises a plurality of output trays, and the controlling section controls the image forming device to output recording paper on which the recording data to which the ID information is added is outputted, to an output tray dedicated to the record data to which the ID information is added.

According to the above-mentioned system, since recording paper on which the record data to which ID information is added is outputted, is outputted to a dedicated output tray, it is possible to prevent the outputted document from being mixed with other documents, and thereby it is possible to improve the security.

Preferably, in the system of the first aspect of the present invention, the transmitting device comprises an ID information transmitting instruction inputting section for inputting an ID information transmitting instruction, and the transmitting device transmits the ID information according to an input of the ID information transmitting instruction.

According to the above-mentioned system, since the transmitting device transmits ID information according to input of an ID information transmitting instruction, it is possible to transmit ID information according to user's demand.

Preferably, in the system of the first aspect of the present invention, the ID information transmitting instruction inputting section includes a biological information reading section for reading biological information from a human body, and the ID information transmitting instruction inputting section transmits the ID information when identity is confirmed based on the biological information.

According to the above-mentioned system, since ID information is not transmitted until identity is confirmed based on biological information, it is possible to prevent others than himself/herself from using the system illicitly.

Preferably, in the system of the first aspect of the present invention, the biological information includes fingerprint.

According to the above-mentioned system, since ID information is not transmitted until identity is verified based on fingerprint, it is possible to prevent others than himself/herself from using the system illicitly.

Preferably, in the system of the first aspect of the present invention, the transmitting device comprises a transmitting state informing section for informing a user of information indicating a transmitting state of the ID information.

According to the above-mentioned system, since the transmitting device informs of information indicating a transmitting state of ID information, it is possible for a user to recognize the transmitting state of ID information.

Preferably, in the system of the first aspect of the present invention, the transmitting state informing section includes a transmitting state displaying section for displaying the information indicating the transmitting state of the ID information.

According to the above-mentioned system, since information indicating a transmitting state of ID information is displayed, it is possible for a user to recognize the transmitting state of ID information.

Preferably, in the system of the first aspect of the present invention, the transmitting state informing section includes a sound generating section for informing the user of the information of the transmitting state of the ID information with sound.

According to the above-mentioned system, since information indicating a transmitting state of ID information is informed with sound, it is possible for a user to recognize the transmitting state of ID information.

Preferably, in the system of the first aspect of the present invention, the image forming device comprises a wireless transmitting section for wirelessly transmitting information indicating an outputting state of the record data to which the ID information is added, and the transmitting device comprises: an outputting state wireless receiving section for receiving the information indicating the outputting state of the record data to which the ID information is added, transmitted from the image forming device; and an outputting state informing section for informing a user of the received information indicating the outputting state of the record data to which the ID information is added.

According to the above-mentioned system, since the transmitting device informs of information indicating an outputting state of record data to which ID information is added, the information being transmitted from the image forming device, it is possible for a user to recognize an outputting state of record data in the image forming device.

Preferably, in the system of the first aspect of the present invention, the outputting state informing section includes an outputting state displaying section for displaying the information indicating the outputting state of the record data to which the ID information is added.

According to the above-mentioned system, since information indicating an outputting state of record data to which ID information is added is displayed, it is possible for a user to recognize the outputting state of record data in the image forming device.

Preferably, in the system of the first aspect of the present invention, the outputting state displaying section displays information indicating an outputting state of a plurality of pieces of record data to each of which the ID information is added.

According to the above-mentioned system, since a plurality of pieces of record data to each of which ID information is added are displayed, it is possible for a user to recognize an outputting state of the plurality of pieces of record data in the image forming device.

Preferably, in the system of the first aspect of the present invention, the outputting state informing section includes a sound generating section for informing the user of the information indicating the outputting state of the record data to which the ID information is added, with sound.

According to the above-mentioned system, information indicating an outputting state of record data to which ID information is added is informed with sound, it is possible for a user to recognize the outputting state of record data in the image forming device.

In accordance with a second aspect of the present invention, an image outputting system comprises: at least one network terminal; at least one image forming device comprising an image forming section for performing a printing on paper based on record data, the at least one image forming device being connected to the at least one image forming device through network; a plurality of transmitting devices each of which is carried by each of a plurality of users who operate the at least one network terminal; and a wireless communicating section for interconnecting wireless communication between the plurality of transmitting devices and the at least one image forming device, wherein each of the plurality of transmitting devices comprises: a storing section for storing ID information for identifying each of the plurality of users carrying each of the plurality of transmitting devices respectively; and an ID information transmitting section for transmitting the ID information stored in the storing section of each the plurality of transmitting devices, to one of the at least one image forming device, each of the at least one network terminal comprises: a storing section in which ID information for identifying each of the plurality of users using the at least one network terminal is in advance stored; and a with-ID-information record data transmitting section for adding the ID information stored in the storing section of each of the at least one network terminal, to the record data, and for transmitting the record data, when one of the at least one network terminal transmits the record data to be printed at the one of the at least one image forming device, to the one of the at least one image forming device, each of the at least one image forming device comprises: a with-ID-information record data receiving section for receiving the record data with the ID information transmitted from the with-ID-information record data transmitting section; an ID information receiving section for receiving the ID information transmitted from the ID information transmitting section through the wireless communicating section; a with-ID-information printing start section for making the one of the at least one image forming device start the printing, when the ID information included in the record data with ID information received by the with-ID-information record data receiving section corresponds to the ID information received by the ID information receiving section, based on the record data including the ID information; and a busy signal transmitting section for transmitting a busy signal through the wireless communicating section while the ID information receiving section is receiving the ID information, and each of the plurality of transmitting devices further comprises: busy signal receiving section for receiving the busy signal transmitted by the busy signal transmitting section, through the wireless communicating section; and an ID information transmitting stop controlling section for controlling the ID information transmitting section to stop transmission of the ID information while the busy signal receiving section is receiving the busy signal.

According to the system of the second aspect of the present invention, in a network-structured image outputting system, while security is made improved so as to prevent printed material by the image forming device from being exposed to other people's eyes against the will of a person who has instructed the printing, waiting time of such a person beside the image forming device is reduced and inconvenience on the operation does not occur even if there are a plurality of users near the image forming device. And therefore, it is possible to provide such an image outputting system.

In other words, according to such a system, since a user approaches to the image forming device, the image forming device receives ID information from the transmitting device carried by the user, and then the image forming device starts the printing, it is possible for the user to surely obtain the outputted printed material, and further it is possible to expose the contents of the material to other people's eyes. Thereby, it is possible to improve the security.

Further, according to such a system, since the image forming device does not start the printing until receiving ID information from the transmitting device carried by a user, the situation of a conventional art, which does not start the printing until a user touches the image forming device, does not happen. Thereby, it is possible to reduce the waiting time until the printing completion in comparison with the conventional art.

Further, according to such a system, if ID information has already been received, other transmitting devices are controlled so as not to transmit ID information. Thereby, even if a structure which is cheaply feasible so that the transmitting device carried by a user does not have a plurality of transmitting frequency channels is adopted, the image forming device does not receive signals from the plurality of transmitting devices, and therefore malfunction due to interference does not happen. Consequently, inconvenience during the operation is not caused.

Preferably, in the system of the second aspect of the present invention, the storing section of each of the plurality of transmitting devices stores, in advance, biological information of one user among the plurality of users, the one user corresponding to the ID information stored therein, and each of the plurality of transmitting devices further comprises: a biological information reading section for reading biological information inputted by each of the plurality of users; and a user identifying section for controlling the ID information transmitting section to transmit the ID information only if the biological information read by the biological information reading section corresponds to the biological information stored in the storing section of the each of the plurality of transmitting devices.

According to the above-mentioned system, the transmitting device transmits ID information by the ID information transmitting section only if biological information read by the biological information reading section corresponds to biological information stored in the storing section of the transmitting device. Therefore, it is possible to prevent others than himself/herself from using the system illicitly.

Preferably, in the system of the second aspect of the present invention, the biological information read by the biological information reading section includes fingerprint of the one user.

According to the above-mentioned system, since ID information is not transmitted until identity is confirmed based on fingerprint, it is possible to prevent others than himself/herself from using the system illicitly.

Preferably, in the system of the second aspect of the present invention, each of the at least one network terminal further comprises a without-ID-information record data transmitting section for transmitting only the record data without the ID information added when transmitting the record data to be printed at one of each of the at least one image forming device, to the one of the at least one the image forming device, and each of the at least one image forming device further comprises: a without-ID-information record data receiving section for receiving the record data transmitted by the without-ID-information record data transmitting section; and a printing without ID information starting section for starting the printing by the image forming section based on the record data, when the without-ID-information record data receiving section receives the record data without ID information.

According to the above-mentioned system, it is possible to output record data to which ID information is not added.

Preferably, in the system of the second aspect of the present invention, each of the at least one network terminal further comprises a printing method selecting section for allowing the plurality of users to select whether to use the with-ID-information record data transmitting section or to use the without-ID-information record data transmitting section at the time of transmitting the record data to be printed at the one of the at least one image forming device, to the one of the at least one image forming device.

According to the above-mentioned system, when record data to be printed by the image forming device is to be transmitted to the image forming device, it is possible for a user to select whether to add ID information to the record data.

Preferably, in the system of the second aspect of the present invention, each of the at least one image forming device further comprises a dedicated output tray for outputting only the paper printed by the image forming section, based on the record data with ID information received by the with-ID-information record data receiving section.

According to the above-mentioned system, since paper which is printed based on record data with ID information is outputted to a dedicated output tray, it is possible to prevent the paper from being mixed up with other documents, and thereby it is possible to improve the security.

Preferably, in the system of the second aspect of the present invention, each of the plurality of transmitting devices further comprises a transmitting state informing section for informing the plurality of users of information indicating a transmitting state of the ID information by the ID information transmitting section.

According to the above-mentioned system, since the transmitting device informs a user of information indicating a transmitting state of ID information by the ID information transmitting section, it is possible for a user to recognize the transmitting state of ID information.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a view showing an outline of a system configuration of an image outputting system 1 according to a first embodiment of the present invention,

FIG. 2 is a block diagram showing a functional structure of an ID card 3a,

FIG. 3 is a block diagram showing a functional structure of an image forming device 4,

FIG. 4A is a view showing a data structure of record data, FIG. 4B is a view showing a data storing area within an image data storing device 48,

FIG. 5 is a flowchart illustrating a record data storing process,

FIG. 6 is a flowchart illustrating an ID information transmitting process 1,

FIG. 7 is a flowchart illustrating an ID information receiving process,

FIG. 8 is a flowchart illustrating an ID identifying process 1,

FIG. 9 is a block diagram showing a functional structure of the ID card 3a in the case of the IrDA communication,

FIG. 10 is a block diagram showing a functional structure of the image forming device 4 in the case of the IrDA communication,

FIG. 11 is a flowchart illustrating an ID identifying process 2 in a second embodiment,

FIG. 12A is a view showing an external structure (surface side) of an ID card 103a in a third embodiment,

FIG. 12B is an external structure (back side) of the ID card 103a in the third embodiment,

FIG. 13 is a block diagram showing a functional structure of the ID card 103a,

FIG. 14 is a block diagram showing a functional structure of an image forming device 104,

FIG. 15 is a process flow illustrating a brief outline of a process in the ID card 103 and the image forming device 104 when the ID card 103a displays a job list and performs a print start instructing operation,

FIGS. 16A to 16N are display examples on an LCD displaying unit 140 of the ID card 103a,

FIGS. 17A and 17B are process flows showing a brief outline of an operation when a plurality of PCs 2a, 2b transmit record data to the image forming device 104,

FIGS. 18A and 18B are flowcharts illustrating a process in the ID card 103a in the third embodiment,

FIG. 19 is a flowchart illustrating a biological identifying process 1 in the ID card 103a,

FIG. 20 is a flowchart illustrating a biological identifying process 2 with a plurality of pieces of biological information,

FIG. 21 is a block diagram showing a functional structure of the ID card 103a in the case of the IrDA communication,

FIG. 22 a block diagram showing a functional structure of the image forming device 104 in the case of the IrDA communication,

FIG. 23 is a view showing an external view of an ID card 203a in an alternative example of the third embodiment,

FIG. 24 is a block diagram showing a functional structure of the ID card 203a,

FIG. 25A is a view showing an external structure of a PDA 303a in a fourth embodiment, FIG. 25B is a view showing an external structure of a PDA 403a in the fourth embodiment,

FIG. 26A is a display example on the LCD displaying unit 140 of the PDA 303a, FIG. 26B is a display example of the LCD displaying unit 140 of the PDA 403a,

FIG. 27A is a display example of a list of all the print jobs to be outputted by the image forming device 104, FIG. 27B is a display example of a list of print jobs of the owner of the PDA 303a to be outputted by the image forming device 104,

FIG. 28 is a block diagram showing a system structure of an image outputting system according to a fifth embodiment of the present invention,

FIG. 29 is a block diagram showing a structure of the digital copying machine 501 shown in FIG. 28,

FIG. 30 is a block diagram showing a structure of the personal computer 502 shown in FIG. 28,

FIG. 31 is a block diagram showing a structure of the portable terminal device 506 shown in FIG. 28,

FIG. 32 is a flowchart illustrating a record data transmitting process which is a process in the personal computer 502 at the time that the personal computer instructs the printing to the digital copying machine, in the operations of the image outputting system according to the fifth embodiment.

FIG. 33 is a flowchart illustrating an ID information transmitting process 2 which is a process performed by the portable terminal device carried by the user A, in the operations of the image outputting system according to the fifth embodiment.

FIG. 34A is a display example in the case that the portable terminal device 506 is not able to transmit ID information because the digital copying machine 501 is in a busy state, among examples of display contents displayed on a displaying section 565 of the portable terminal device 506, FIG. 34B is a display example in the case that ID information is being transmitted to the digital copying machine 501 among the examples of display contents displayed on the displaying section 565 of the portable terminal device 506, FIG. 34C is a display example in the case that the digital copying machine 501 is outputting print, that is, the printing of assigned record data is being performed, among the examples of display contents displayed on the displaying section 565 of the portable terminal device 506, and

FIG. 35 is a flowchart illustrating an ID identifying process 3 which is a process in the digital copying machine at the time of receiving record data with ID information from the personal computers, in the operations of the image outputting system in the fifth embodiment.

### EMBODIMENTS OF THE INVENTION

[First Embodiment]

Hereinafter, an embodiment according to the present invention will be described with reference to figures.

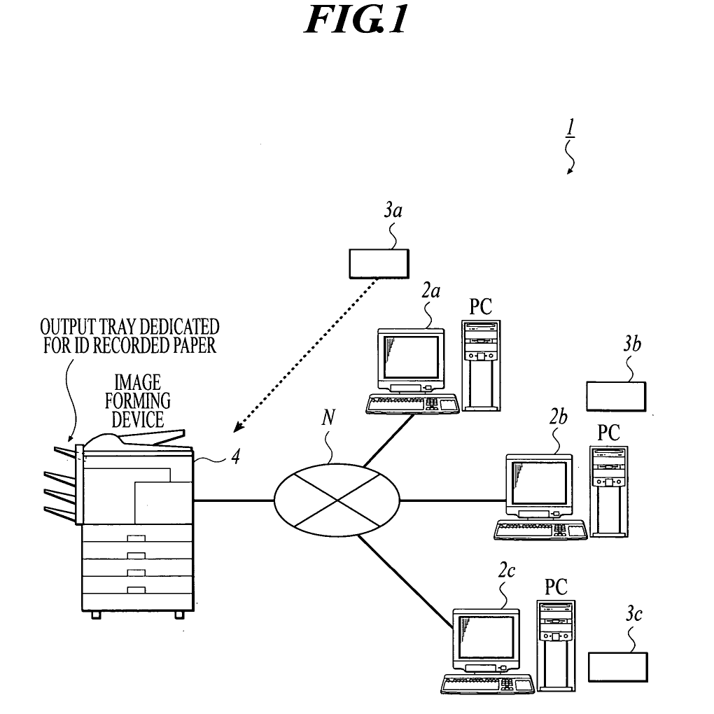

FIG. 1 shows a system structure of an image outputting system 1 in the first embodiment of the present invention. As shown in FIG. 1, the image outputting system 1 comprises a plurality of PCs 2a, 2b, 2c, . . . , a plurality of ID cards 3a, 3b, 3c, . . . , and an image forming device 4. Here, the PCs 2a, 2b, 2c, . . . and the image forming device 4 are connected through a network N.

The PCs 2a, 2b, 2c, . . . , are network terminals used by each user, and are capable of generating record data such as a document, an image or the like, and of transmitting the record data to the image forming device 4 to be outputted. When the record data is to be transmitted from PCs 2a, 2b, 2c, . . . , to the image forming device 4, each user selects whether to add ID information corresponding to himself/herself, to the record data. For example, if an important document or the like is to be outputted, the PCs 2a, 2b, 2c, . . . transmit record data to which ID information is added.

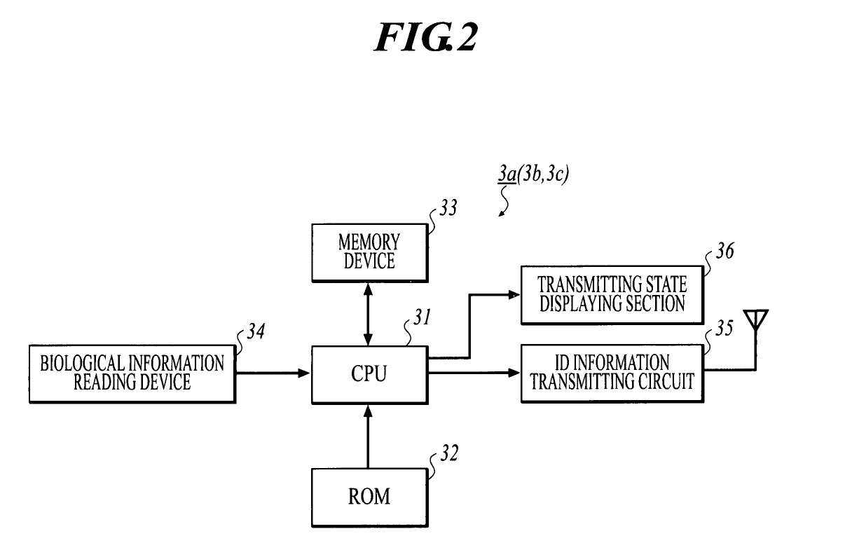

The ID cards 3a, 3b, 3c, . . . , are transmitting devices corresponding to each ID information, and are always carried by each user. FIG. 2 shows a functional structure of the ID card 3a. The ID card 3a comprises a CPU (Central Processing Unit) 31, a ROM (Read Only Memory) 32, a memory device 33, a biological information reading device 34, an ID information transmitting circuit 35 and a transmitting state displaying section 36.

The CPU 31, in response to a signal inputted from the biological information reading device 34, loads various types of control programs recorded in the ROM 32, develops them into RAM (not illustrated), and executes various processes in conjunction with each developed control program for making each part of the ID card 3a operate. The ROM 32 is an nonvolatile semiconductor memory, and records a fundamental program to be executed by the CPU 31, data and the like.

The memory device 33 comprises an onetime memory on which writing can be done only once, and a memory on which reading and writing can be done, the memory being used as a work memory in the case of executing the various processes. The onetime memory stores biological information and ID information of an owner of the ID card 3a. One pair of these information is written in one ID card. A writing operation of these information is, for example, done by a PC or the like with the use of a dedicated I/F circuit (not illustrated).

The biological information reading device 34 comprises an electrode. Based on a change in resistance or a change in capacitance of a finger being touched to the electrode, the biological information reading device 34 reads fingerprint information as biological information, the fingerprint information being gradation digital data for pattern recognition converted according to the measurement of a current difference generated from a difference between contacted area and uncontacted area of the finger of the owner and the electrode.

The ID information transmitting circuit 35 wirelessly transmits ID information for a predetermined time period (for example, 3 minutes) if the biological information read by the biological information reading device 34 corresponds to the biological information stored in the memory device 33. At this time, the ID information transmitting circuit 35 transmits the ID information at one predetermined frequency channel among a plurality of transmitting frequency channels. As the wireless communication method, for example, the HomeRF (Home Radio Frequency) method being wireless communication with the use of electric wave, the Bluetooth method, the Wi-Fi (Wireless Fidelity: a wireless communication LAN with the standard of IEEE 802.11a/IEEE 802.11b/IEEE 802.11g) method and the like can be cited.

The transmitting state displaying section 36 comprises, for example, a single color LED (Light Emitting Diode), and it displays that it is in a transmitting state by blinking (or turning on) the single color LED while the ID information transmitting circuit 35 is transmitting the ID information.

The ID cards 3b, 3c, . . . have the same structure as the ID card 3a. Therefore, the description thereof is omitted.

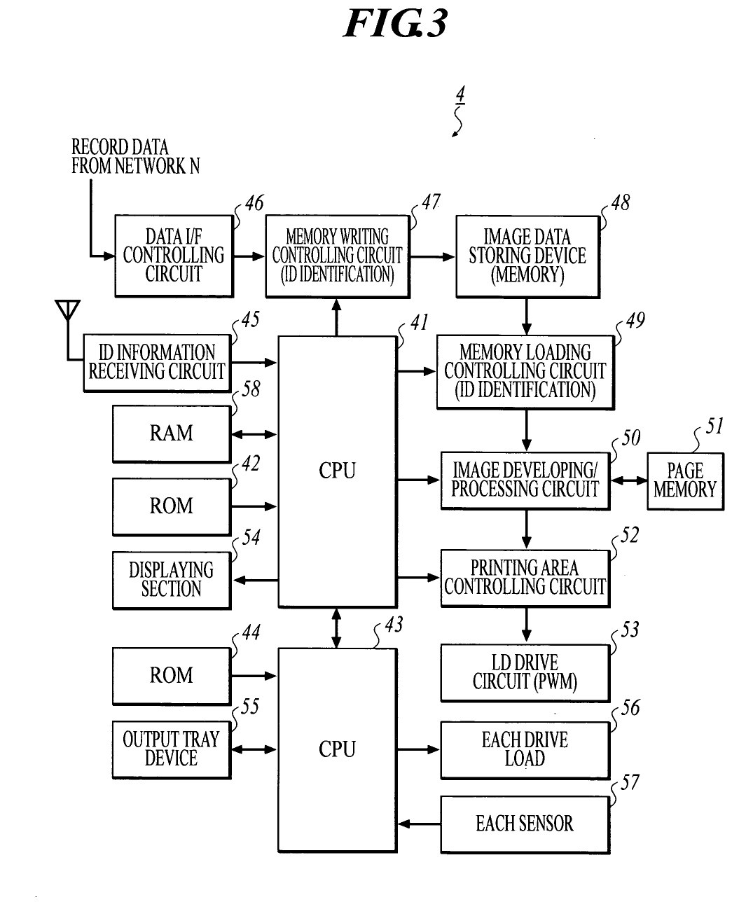

FIG. 3 shows a functional structure of the image forming device 4. The image forming device 4 comprises a CPU 41, a ROM 42, a CPU 43, a ROM 44, an ID information receiving circuit 45, a data I/F controlling circuit 46, a memory writing controlling circuit 47, an image data storing device 48, a memory loading controlling circuit 49, an image developing/processing circuit 50, a page memory 51, a printing area controlling circuit 52, an LD drive circuit 53, a display section 54, an output tray device 55, each drive load 56, each sensor 57, a RAM (Random Access Memory) 58 and the like.

The CPU 41 integrally controls circuits of the image-processes and the state of the entire image forming device. The CPU 41 develops a program assigned among various types of programs recorded in the ROM 42 into a work area of the RAM 58, executes the various types of processes in conjunction with the above-mentioned program, and stores the process result in a predetermined area of the RAM 58. The ROM 42 comprises a nonvolatile semiconductor memory, and records the various types of programs of the image forming device 4 executed by the CPU 41, data and the like.

The CPU 43 controls each drive system that performs the image forming operation in the image forming device 4. The CPU 43 develops a program assigned among the various types of programs recorded in the ROM 44 into a work area of a RAM (not shown), executes the various types of programs in conjunction with the above-mentioned program, and stores the transaction result in a predetermined area of the RAM. The ROM 44 comprises a nonvolatile semiconductor memory, and records the various types of programs of the image forming device 4 to be executed by the CPU 43, data and the like.

The ID information receiving circuit 45 receives ID information transmitted wirelessly from the ID information transmitting circuit 35 of the ID cards 3a, 3b, 3c, . . . . The ID information received by the ID information receiving circuit 45 is temporarily stored in the RAM 58.

The data I/F controlling circuit 46 receives record data transmitted from the PCs 2a, 2b, 2c, . . . through the network N, and outputs them to the memory writing controlling circuit 47.

The memory writing controlling circuit 47 outputs the record data received by the data I/F controlling circuit 46 to the image data storing device 48, according to an instruction from the CPU 41. At this time, record data is stored in a different storing area, based on whether ID information is added to the record data.

The image data storing device 48 comprises an HDD (Hard Disk Drive) or a memory, and stores the record data transmitted from each of the PCs 2a, 2b, 2c, . . . .

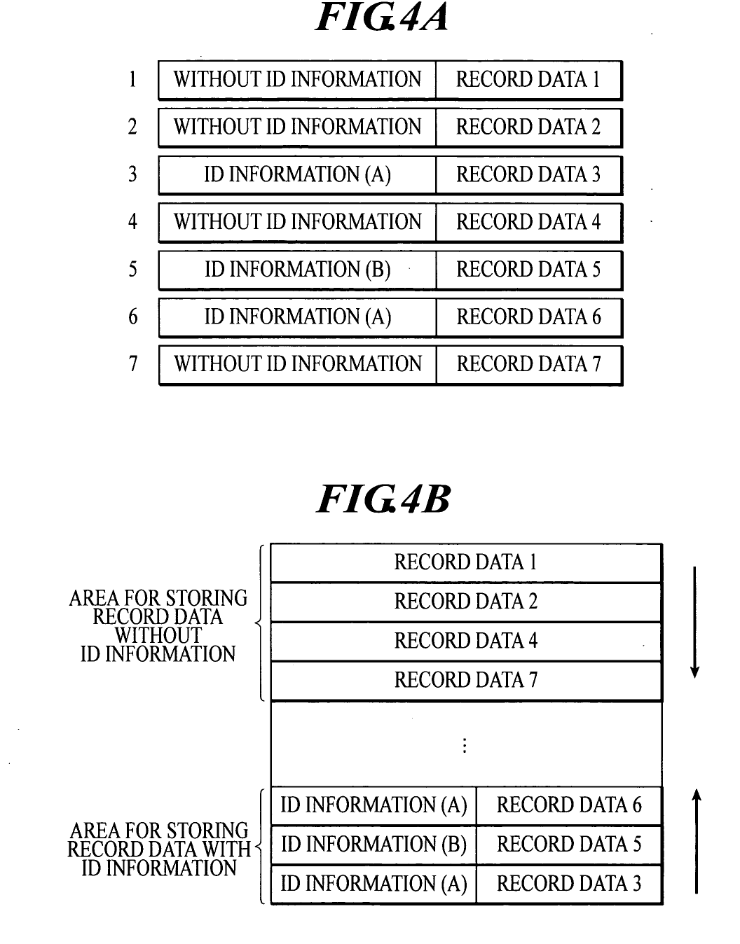

FIG. 4A shows a data structure of the record data. Here, a case where the data. I/F controlling circuit 46 receives the record data in the order shown in FIG. 4A will be described. In the case that the PCs 2a, 2b, 2c, . . . transmit record data with ID information added, the ID information is written in a header of the record data. Here, while ID information is not added to the first, second, fourth and seventh record data, ID information (A) is added to the third and sixth record data and ID information (B) is added to the fifth record data. Here, the ID information (A) is ID information corresponding to a user A using the PC 2a, and the ID information (B) is ID information corresponding to a user B using the PC 2b.

As shown in FIG. 4B, the data storing area of the image data storing device 48 is preferably divided into an area for storing record data with ID information and an area for storing record data without ID information. As shown in FIG. 4B, record data is classified in the receiving order according to whether ID information is added or not, and is stored in the corresponding area accordingly. Thereby, when ID information is searched for among record data to which ID information is added, since it is not necessary to search the entire data storing area but only to search the area storing record data with ID information, it is possible to reduce the time for the search. Here, the method for storing record data in the image data storing device 48 can be a method of storing record data in its receiving order, a method of looking for a retrieved area by the completion of a job process (“job” means an image outputting operation at a unit of one outputting command when the image forming device 4 outputs an image) and storing record data in the empty area, a method of filling an empty area or the like, and therefore, the method for storing record data is not limited to the one shown in FIG. 4B.

The memory loading controlling circuit 49, when the ID information receiving circuit 45 receives ID information, compares the ID information received by the ID information receiving circuit 45 with ID information added to the record data stored in the image data storing device 48, according to an instruction from the CPU 41. If these ID information correspond to each other, the memory loading controlling circuit 49 outputs the record data to which the ID information is added, to the image developing/processing circuit 50. The memory loading controlling circuit 49 sequentially outputs the record data to which ID information is not added, to the image developing/processing circuit 50.

The image developing/processing circuit 50 develops compressed record data, applies various types of image processes on it, and stores it in the page memory temporarily. When the corresponding turn of outputting the record data comes, the record data stored in the page memory 51 is outputted to the printing area controlling circuit 52.

The printing area controlling circuit 52 generates a signal which determines an image printing area on recording paper based on the record data loaded from the page memory 51, according to an instruction from the CPU 41, and outputs the signal to the LD drive circuit 53.

The LD drive circuit 53 controls the drive of an LD according to PWM (Pulse Width Modulation), and forms an image on the recording paper according to the electrophotographic method.

The display section 54 comprises an LCD (Liquid Crystal Display) or the like, and displays a screen according to a display signal from the CPU 41.

To the output tray device 55, the recording paper on which the image is formed is outputted. The image forming device 4 comprises a plurality of output trays, and recording paper on which record data to which ID information is added is to be outputted to a dedicated output tray.

A control signal is outputted from the CPU 43 to each drive load 56. Further, a signal from each sensor 57 is outputted to the CPU 43.

The network N may include LAN, WAN (Wide Area Network) and Internet. Further, the network N may include a telephone line network, ISDN (Integrated Services Digital Network), ADSL (Asymmetric Digital Subscriber Line), mobile communication network, satellite communication network, CATV network, optical communication network, wireless communication network and the like.

Next, an operation of the present embodiment will be described.

(Record Data Storing Process)

FIG. 5 is a flowchart illustrating a record data storing process. The record data storing process is a process performed by the image forming device 4 after the PCs 2a, 2b, 2c, . . . generate record data of an image, a text or the like and transmits the record data to the image forming device 4 through the network N.

First, the image forming device 4 receives the record data transmitted from the PCs 2a, 2b, 2c, . . . (Step S1). If ID information is added to the record data (Step S2;YES), the record data is stored in the area for storing record data with ID information in the image data storing device 48 (Step S3). If ID information is not added to the record data (Step S2;NO), the record data is stored in the area for storing record data without ID information (Step S4).

With the above, the record data storing process is completed.

(ID Information Transmitting Process 1)

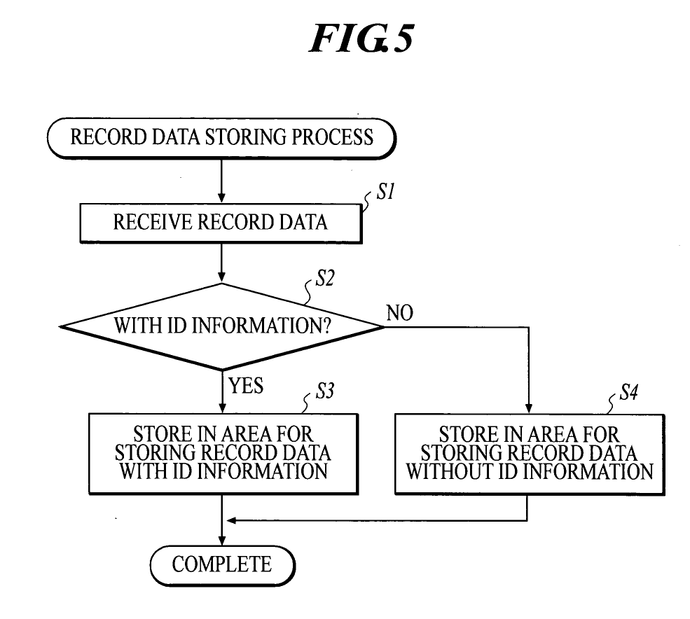

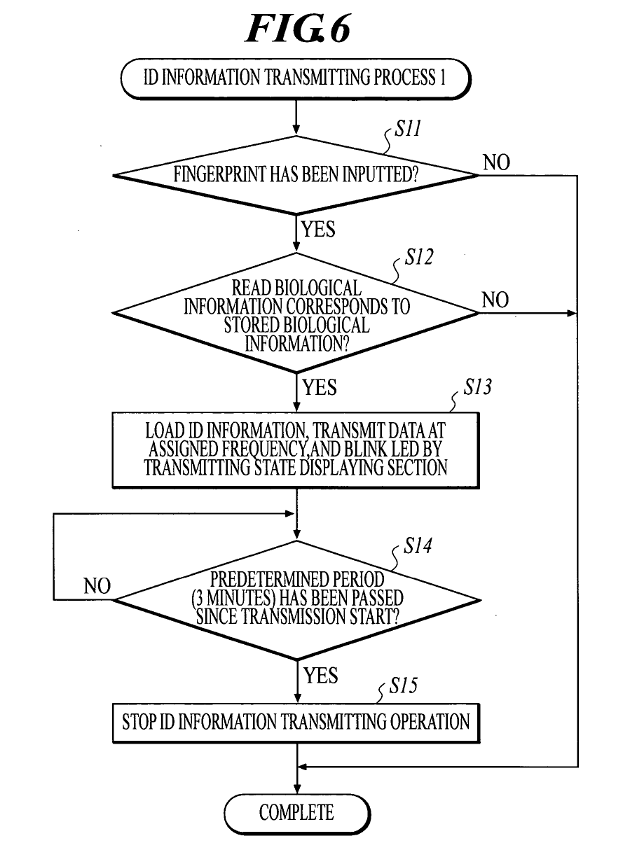

FIG. 6 is a flowchart illustrating an ID information transmitting process 1 performed by the ID cards 3a, 3b, 3c, . . . . The ID information transmitting process 1 is a process performed while a user who has instructed the output of record data at the PCs 2a, 2b, 2c, . . . is approaching the image forming device 4.

First, the biological information reading device 34 judges whether fingerprint has been inputted (Step S11). If there has been an input of fingerprint (Step S11;YES), the biological information reading device 34 judges whether the biological information read by the biological information reading device 34 corresponds to biological information stored in the memory device 33 (Step S12).

If the biological information read by the biological information reading device 34 corresponds to biological information stored in the memory device 33 (Step S12;YES), the ID information is loaded from the memory device 33, and wirelessly transmitted at assigned frequency. While the ID information is being transmitted, LED is being blinked by the transmitting state displaying section 36. (Step S13). Thereafter, whether a predetermined period (for example, three minutes) has passed since the start of transmitting the ID information is judged (Step S14), and if the predetermined period has passed (Step S14;YES), the transmitting operation of the ID information and the blinking of the LED are stopped (Step S15).

With the above, the ID information transmitting process 1 is completed.

(ID Information Receiving Process)

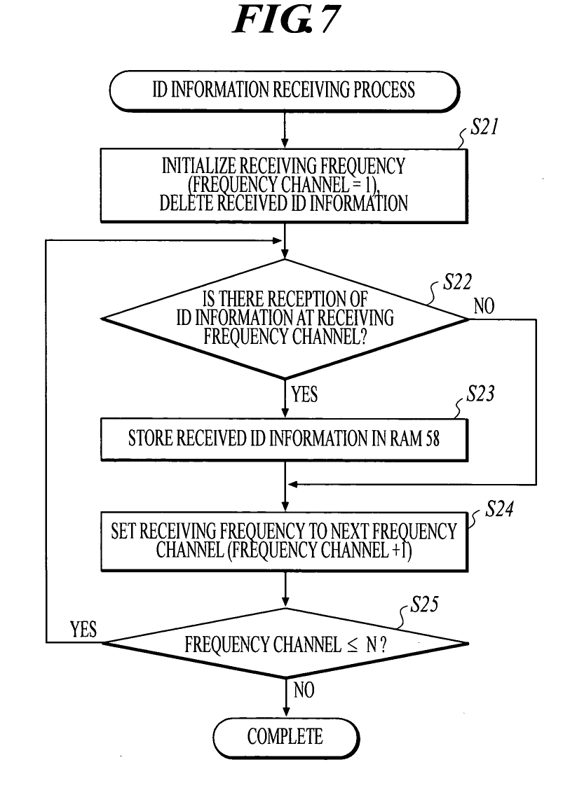

FIG. 7 is a flowchart illustrating an ID information receiving process. The ID information receiving process is a process performed as timer interrupt of 10 ms to 500 ms in the image forming device 4, and it samples whether ID information has been received. Here, the number of channels of receiving frequency at which the ID cards 3a, 3b, 3c, . . . transmits the record data and the image forming device 4 receives the record data is assumed to be N.

First, the receiving frequency is initialized (set: frequency channel=1), and thereby all the ID information received from the ID cards 3a, 3b, 3c, . . . is deleted from the RAM 58 (Step S21).

Next, whether there is reception of ID information at the frequency channel is judged (Step S22). If there is reception of ID information (Step S22;YES), the received ID information is stored in the RAM 58 (Step S23).

Then, the receiving frequency is set to the next frequency channel (=2) (Step S24). Similarly, at each time that the frequency channel increases by one, Step S22 to Step 24 are repeated. When the frequency channel exceeds N (Step S25;NO), the ID information receiving process is completed.

(ID Identifying Process 1)

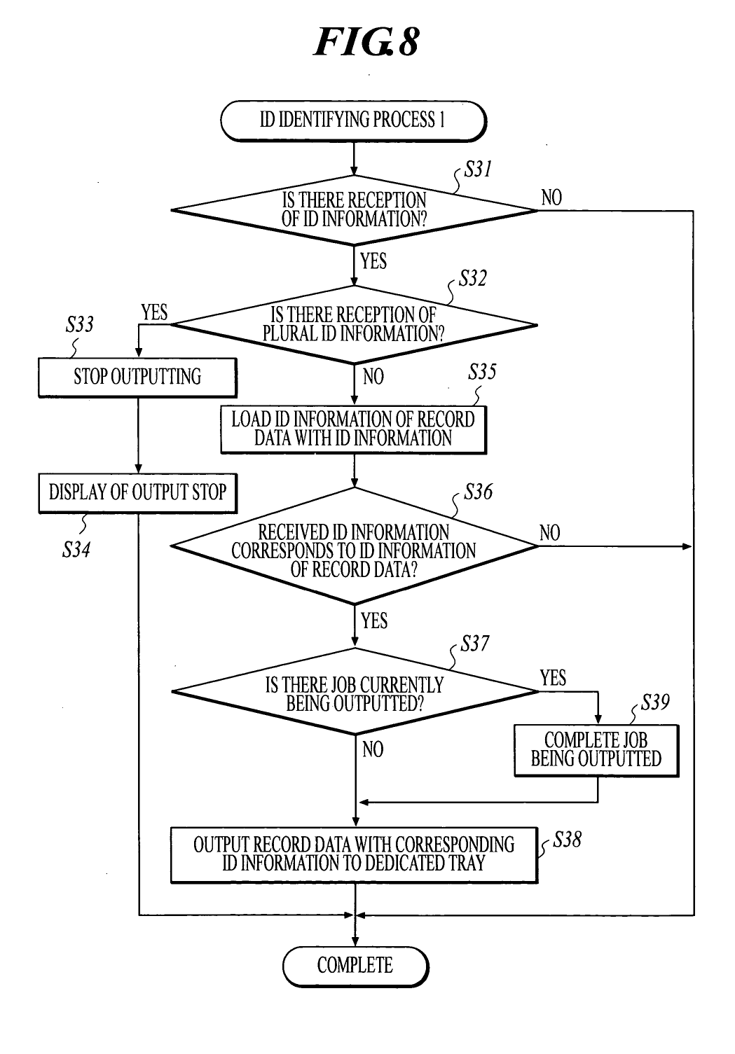

FIG. 8 is a flowchart illustrating an ID identifying process 1. The ID identifying process 1 is a process performed by the image forming device 4 at the time of outputting record data.

First, whether there is reception of ID information is judged (Step S31, see ID information receiving process of FIG. 7).

If there is reception of ID information (Step S31;YES), whether a plurality of pieces of ID information are received (Step S32). If a plurality of pieces of ID information are received (Step S32;YES), outputting record data in the image forming device 4 is stopped (Step S33), and information about the stop is displayed on the display section 54 (step S34).

If only one piece of ID information is received (Step S32;NO), ID information of record data with ID information stored in the image data storing device 48 is loaded (Step S35). Then, whether the received ID information corresponds to ID information added to the record data is judged (Step S36). If the received ID information corresponds to the ID information being added to the record data (Step S36;YES), whether there is a job currently being outputted is judged (Step S37).

If there is no job currently being outputted (Step S37;NO), record data to which the corresponding ID information is added is outputted to a dedicated tray (Step S38).

If there is a job being outputted in Step S37 (Step S37;YES), after the job being outputted is completed (Step S39), record data to which the corresponding ID information is added is outputted to a dedicated tray (Step S38).

With the above, the ID identifying process 1 is completed.

According to the image outputting system 1 in the first embodiment, if ID information added to record data corresponds to ID information received from the ID cards 3a, 3b, 3c, . . . , the record data to which the ID information is added is outputted. Thereby, it is possible to improve the security without having a user wait. Further, if a plurality of pieces of ID information are received, outputting the record data to which the ID information is added is stopped. Thereby, it is possible to prevent others from obtaining an outputted document. Further, since recording paper on which the record data to which the ID information is added is outputted, is outputted to a dedicated tray, it is possible to prevent the outputted document from being mixed with other documents, and thereby it is possible to improve the security.

Further, when ID information being added to record data corresponds to ID information received from the ID cards 3a, 3b, 3c, . . . , if there is a job currently being outputted, after outputting the job is completed, the record data to which the ID information is added is outputted. Thereby, by interrupting into other jobs which are scheduled to be outputted after the job being outputted, it is possible to output the record data to which the ID information is added. As a result, it is possible to reduce the waiting time of a user.

Further, it is possible to output the document to which ID information is not added, which has low confidentiality, without having a condition.

Further, the ID cards 3a, 3b, 3c, . . . do not transmit ID information until a user is identified as himself/herself based on biological information. Thereby, it is possible to prevent others than himself/herself from using the system, illicitly.

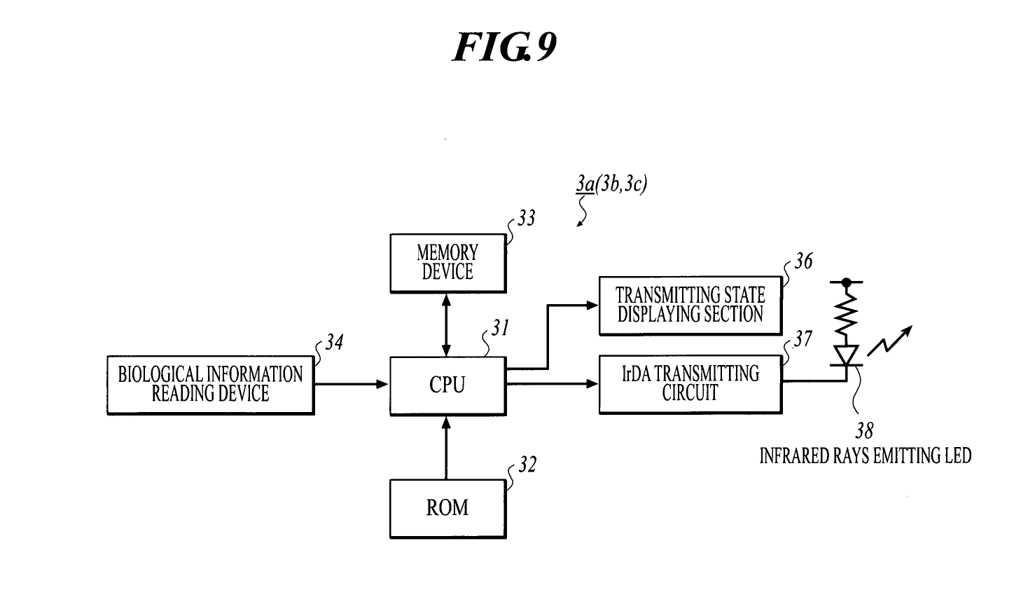

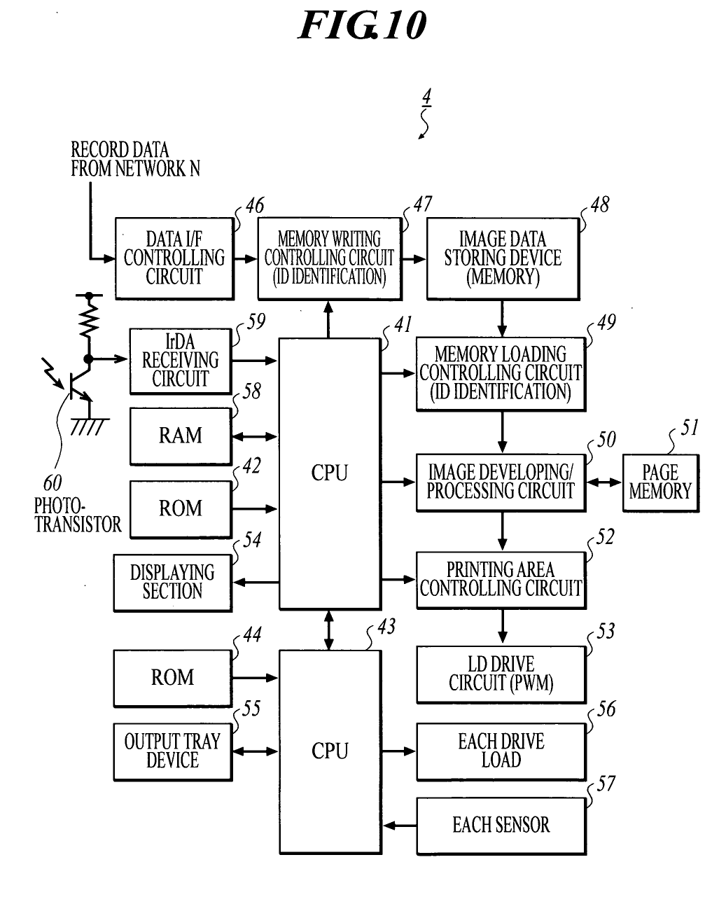

Here, for the transmission of ID information from the ID cards 3a, 3b, 3c, . . . to the image forming device 4, IrDA (Infrared Data Association) may be used. In this case, the ID cards 3a, 3b, 3c, . . . comprise, instead of the ID information transmitting circuit 35 shown in FIG. 2, an IrDA transmitting circuit 37 and an infrared rays emitting LED 38, as shown in FIG. 9. Since the other component parts are approximately the same as those of the ID cards 3a, 3b, 3c, . . . shown in FIG. 2, identical numeral is added to those component parts and description thereof is omitted. If biological information read by the biological information reading device 34 corresponds to biological information stored in the memory device 33, the IrDA transmitting circuit 37 drives the infrared rays emitting LED 38 to emit infrared rays. Further, the image forming device 4 comprises, instead of the ID information receiving circuit 45 shown in FIG. 3, an IrDA receiving circuit 49 and a phototransistor 60 as shown in FIG. 10. Since the other component parts are approximately the same as those of the image forming device shown in FIG. 3, identical numeral is added to those component parts and description thereof is omitted. The phototransistor 60 receives infrared rays and converts them into electrical signals. The IrDA receiving circuit 59 receives the electrical signals converted by the phototransistor 60.

[Second Embodiment]

Next, a second embodiment to which the present invention is applied will be described.

In an image outputting system according to the second embodiment, identical numeral is added to identical component parts to those of the image outputting system 1 according to the first embodiment, and illustration and description of the identical component parts are omitted. Further, since the same is applied to the record data storing process, the ID information transmitting process 1 and the ID information receiving process each being described in the first embodiment, description thereof is also omitted. Hereinafter, processes characteristic to the second embodiment will be described.

(ID Identifying Process 2)

FIG. 11 is a flowchart illustrating an ID identifying process 2. The ID identifying process 2 is a process performed in the image forming device 4 at the time of outputting record data. Identical numeral is added to identical corresponding process in the ID identifying process 1 shown in FIG. 8, and description of the identical corresponding process is omitted.

In Step S37, if there is a job being outputted (Step S37;YES), an image forming operation of the job being outputted is stopped and a state at the time of the stop is stored (Step S40). Then, record data to which corresponding ID information is added is outputted to a dedicated tray (Step S41). After the record data with ID information is outputted, the image forming operation of the job being in the stop state is resumed (Step S42).

With the above, the ID identifying process 2 is completed.

According to the image outputting system in the second embodiment, when ID information being added to record data corresponds to ID information received from the ID cards 3a, 3b, 3c, . . . , when there is a job currently being outputted, the job being outputted is stopped. Thereby, it is possible to output record data to which ID information is added without having a user wait.

[Third Embodiment]

Next, a third embodiment to which the present invention is applied will be described.

Since an image outputting system according to the third embodiment has different structures from the ID cards 3a, 3b, 3c, . . . and the image forming device 4 in the image outputting system 1 shown in FIG. 1 in comparison, the numeral is added as ID cards 103a, 103b, 103c, . . . , and an image forming device 104. Identical numeral is added to identical corresponding other component parts, and illustration and description of those component parts are omitted. Hereinafter, structures and processes characteristic to the third embodiment will be described.

FIGS. 12A and 12B show an external structure of an ID card 103a in the third embodiment. The other ID cards 103b, 103c, . . . have the same structure. As shown in FIG. 12A, on the surface of the ID card 103a, owner's facial portrait, name and the like are printed. Further, as shown in FIG. 12B, on the back surface of the ID card 103a, provided are an LCD displaying unit 140, an operation SW (switch) 145, an biological information reading device 136 and microphone 144. Further, at the side of the ID card 103a, provided is an I/F connector 146a for having connection to external devices. As the ID card 103a, for example, it is possible to use an employee certificate of a company.

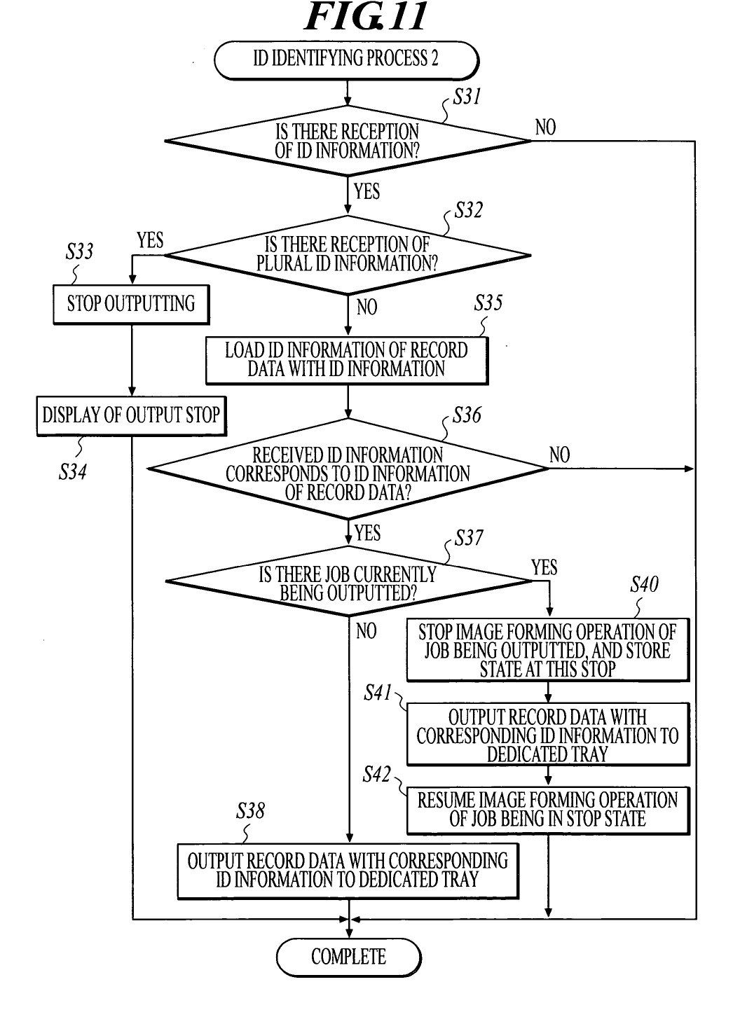

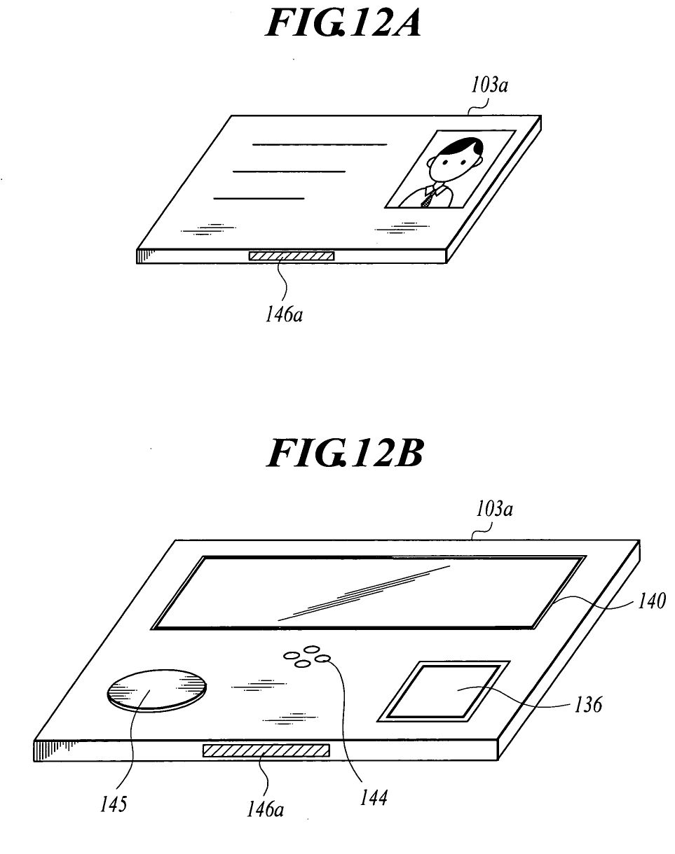

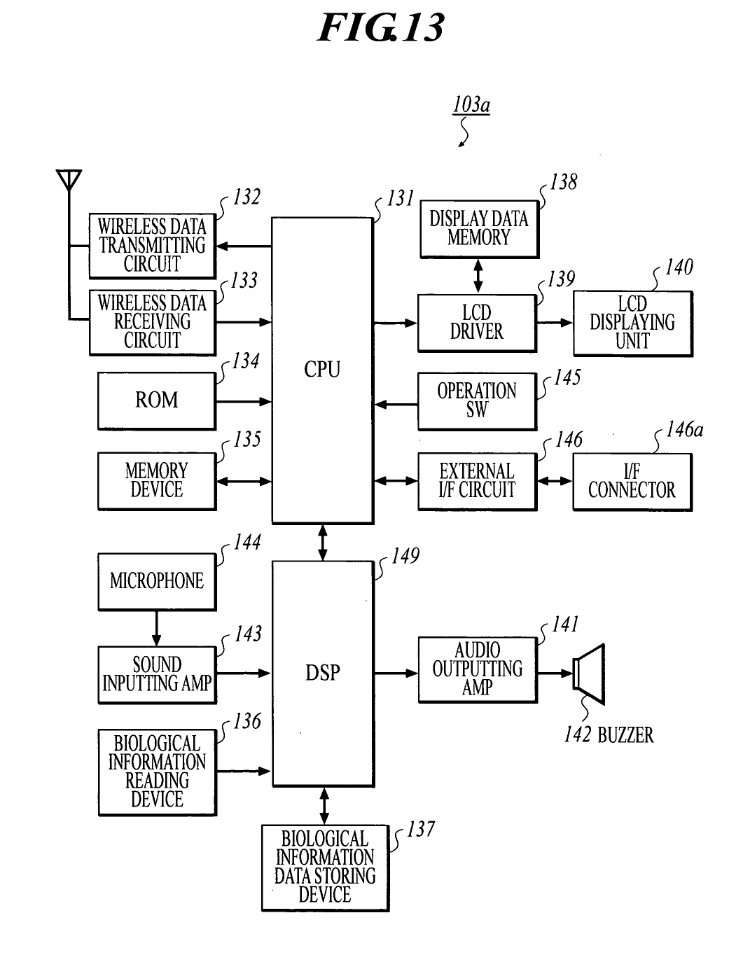

FIG. 13 shows a functional structure of the ID card 103a. As shown in FIG. 13, the ID card 103a comprises a CPU 131, a wireless data transmitting circuit 132, a wireless data receiving circuit 133, a ROM 134, a memory device 135, the biological information reading device 136, a biological information data storing device 137, a display data memory 138, an LCD driver 139, the LCD displaying unit 140, an audio outputting AMP 141, a buzzer 142, a sound inputting AMP 143, the microphone 144, the operation SW 145, an external I/F circuit 146 and DSP (Digital Signal Processor) 149. As a power source of the ID card 103a, a lithium battery, and rechargeable battery such as nickel hydride battery and the like can be used.

The CPU 131, in response to an instruction inputted from the operation SW 145 or the biological information reading device 136, loads various types of control programs recorded in the ROM 134, develops them into RAM (not shown), and executes various processes in conjunction with each developed control program for making each part of the ID card 103a operate. The ROM 134 comprises a nonvolatile semiconductor memory (for example, a flash memory that is capable of electrically erasing and writing as many times as possible is used), and records fundamental programs to be executed by the CPU 131, data and the like.

The wireless data transmitting circuit 132 wirelessly transmits data such as ID information and the like from an antenna. The radio data receiving circuit 133 wirelessly receives data. As the wireless communication method, for example, the HomeRF method being wireless communication with the use of electric wave, the Bluetooth method, the Wi-Fi method (a wireless communication LAN with the standard of IEEE 802.11a/IEEE 802.11b/IEEE 802.11g) and the like can be cited.

The memory device 135 comprises a flash memory, and stores ID information of an owner of the ID card 103a.

The biological information reading device 136 reads biological information from a human body. The biological information reading device 136 has a function to turn on the power of the ID card 103 from the OFF state, in addition to the function of reading biological information. Further, when biological information is being inputted for not less than two seconds, the biological information reading device 136 has a function as an ID information transmission instructing section.

If fingerprint is used as the biological information, the biological information reading device 136 reads a pattern of fingerprint of a finger of the owner, based on a change in resistance of the finger being contacted with a semiconductor electrode, or a difference of electric charge between peaks and troughs occurred according to the pushed finger.

If voiceprint is used as the biological information, the biological information reading device 136 analyses frequency of voice inputted from the microphone 144 with fast Fourier transform, and extract a pattern of sound spectrogram (plotted frequency component with respect to time axis).

The biological information data storing device 137 comprises a flash memory, and in advance stores biological information of the owner of the ID card 103a. Here, biological pattern generated by a pattern calculating process based on biological information is stored as a reference pattern to be a reference at the time of an biological identifying process.

The display data memory 138 stores display data to be displayed on the LCD displaying unit 140. The LCD driver 139 drives the LCD displaying unit 140 based on the display data.

The LCD displaying unit 140 displays the display data stored in the display data memory 138. The display on the LCD displaying unit 140 may be performed with a dot display capable of displaying detailed images, or a character display displaying only characters and marks.

The audio outputting AMP 141 amplifies sound on which the DSP 149 has applied a sound process and outputs the amplified sound to the buzzer 142. The buzzer 142 outputs buzzer sound. Instead of the buzzer 142, the ID card 103a may comprise a speaker for outputting audio assist of the characters displayed on the LCD displaying unit 140, or for outputting the audio assist with buzzer sound added.

The sound inputting AMP 143 amplifies the voice inputted from the microphone 144 and outputs it to the DSP 149.

When the owner pushes the operation SW 145, the operation SW 145 outputs a pushed signal to the CPU 131. As an operation section other than the operation SW 145, the ID card 103a may comprise a touch panel so as to make the touch panel cover the display screen of the LCD displaying unit 140, wherein a coordinate touched as the instruction is detected based on a principle of reading a coordinate according to electromagnetic induction, magnetostriction, pressure sensing or the like, and the detected coordinate is outputted to the CPU as a position signal.

The external I/F circuit 146 is an interface circuit for having connection to a PC via an I/F connector 146a, and it is used at the time of writing a control program recorded in the ROM 134, ID information stored in the memory device 135 and biological information stored in the biological information data storing device 137, in the ID card 103a. Writing each data is performed after a user is identified as himself/herself with the use of ID information and a password, for the purpose of preventing falsification.

Here, rewriting data may be performed by a dedicated rewriting device (not shown) with the use of communication function of the ID card 103a, without using the external I/F circuit 146. Further, at the time of storing biological information in the biological information data storing device 137, biological information may be read by the biological information reading device 136 after a user is identified as himself/herself with the use of ID information and a password, by using the ID card 103a.

The DSP 149 performs high-speed calculating process such as image process judgment of biological information, a sound process and the like.

If the ID card 103a has been turned on and there has been no input from the biological information reading device 136 or the operation SW 145 for five minutes continuously, the power is turned off.

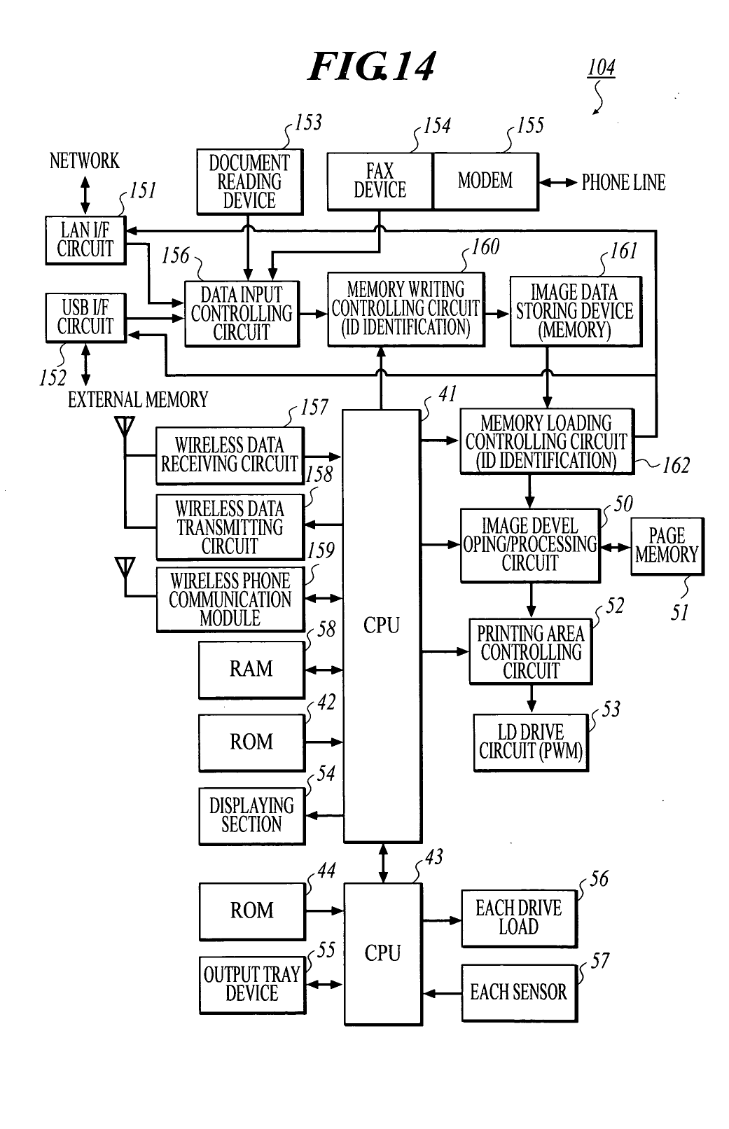

FIG. 14 shows a functional structure of the image forming device 104. The image forming device 104 comprises the CPU 41, the ROM 42, the CPU 43, the ROM 44, the image developing/processing circuit 50, the page memory 51, the printing area controlling circuit 52, the LD drive circuit 53, the display section 54, the output tray device 55, each drive load 56, each sensor 57, the RAM 58, a LAN I/F circuit 151, a USB I/F circuit 152, a document reading device 153, a FAX device 154, a modem 155, a data input controlling circuit 156, a wireless data receiving circuit 157, a wireless data receiving circuit 158, a wireless phone communication module 159, a memory writing controlling circuit 160, an image data storing device 161, a memory loading controlling circuit 162 and the like.

In the image forming device 104, identical numeral is added to identical component parts to those of the image forming device 4 shown in FIG. 3, and description of its structure is omitted.

The LAN I/F circuit 151 is an interface circuit for having connection to the network N, and performs the input of record data through the network N, and the transmission of data read by the document reading device 153 or data received by the FAX device 154.

The USB I/F circuit 152 is an interface circuit for connecting to an external memory, and performs the input of record data from the external memory and the transmission of the record data to the external memory.

The document reading device 153 comprises a light source, a lens, a CCD and the like, and reads an image of a document by imaging reflected light of light scanned on the document from the light source and photoelectrically converting it.

The FAX device 154 transmits/receives an image by being connected to a phone line via the modem 155.

The data input controlling circuit 156 outputs data inputted from the LAN I/F circuit 151, the USB I/F circuit 152, the document reading device 153 or the FAX device 154 to the memory writing controlling circuit 160.

The wireless data receiving circuit 157 receives wireless data such as ID information or the like wirelessly transmitted from the wireless data transmitting circuit 132 of the ID card 103a.

The wireless data transmitting circuit 158 transmits wireless data.

The wireless phone communication module 159 communicates with a cellular phone, a PHS (Personal Handyphone System) and the like.

The memory writing controlling circuit 160 outputs data inputted from the data input controlling circuit 156 to the image data storing device 161 according to an instruction from the CPU 41. At this time, in regard to record data received by the LAN I/F circuit 151, based on whether ID information is added to the record data or not, the record data is stored in a different storing area.

The image data storing device 161 comprises an HDD or a memory, and stores record data from the network N or the external memory, data read by the document reading device 153, and data received by the FAX device 154.

When the wireless data receiving circuit 157 receives ID information, the memory loading controlling circuit 162 compares the ID information received by the wireless data receiving circuit 157 with ID information added to record data stored in the image data storing device 161. If these ID information correspond to each other, the memory loading controlling circuit 162 outputs the record data to which the corresponding ID information is added to the image developing/processing circuit 50. The memory loading controlling circuit 162 sequentially outputs the record data to which ID information is not added, to the image developing/processing circuit 50. Here, data read by the document reading device 153 may be transmitted to external devices via the LAN I/F circuit 151 or the USB I/F circuit 152.

Next, an operation of the present embodiment will be described.

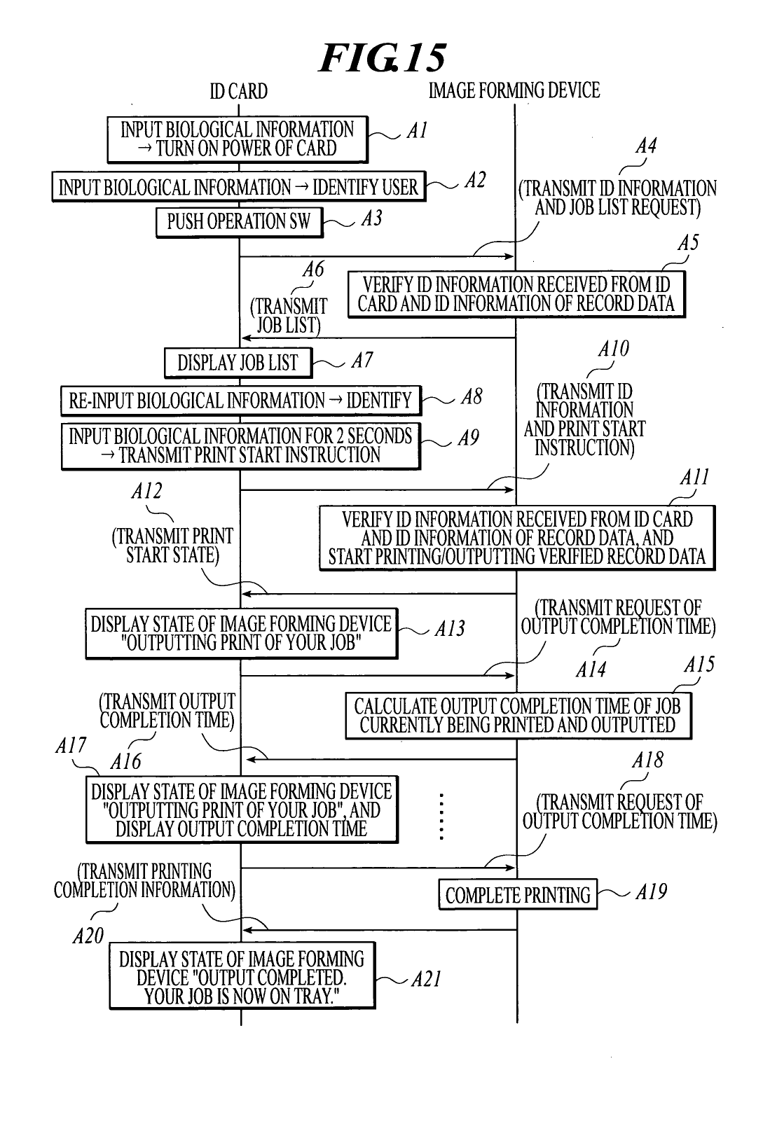

First, with reference to FIG. 15, an overview of processes in the ID card 103a and the image forming device 104 at the time of performing a display of a job list and an operation of a print start instruction will be described.

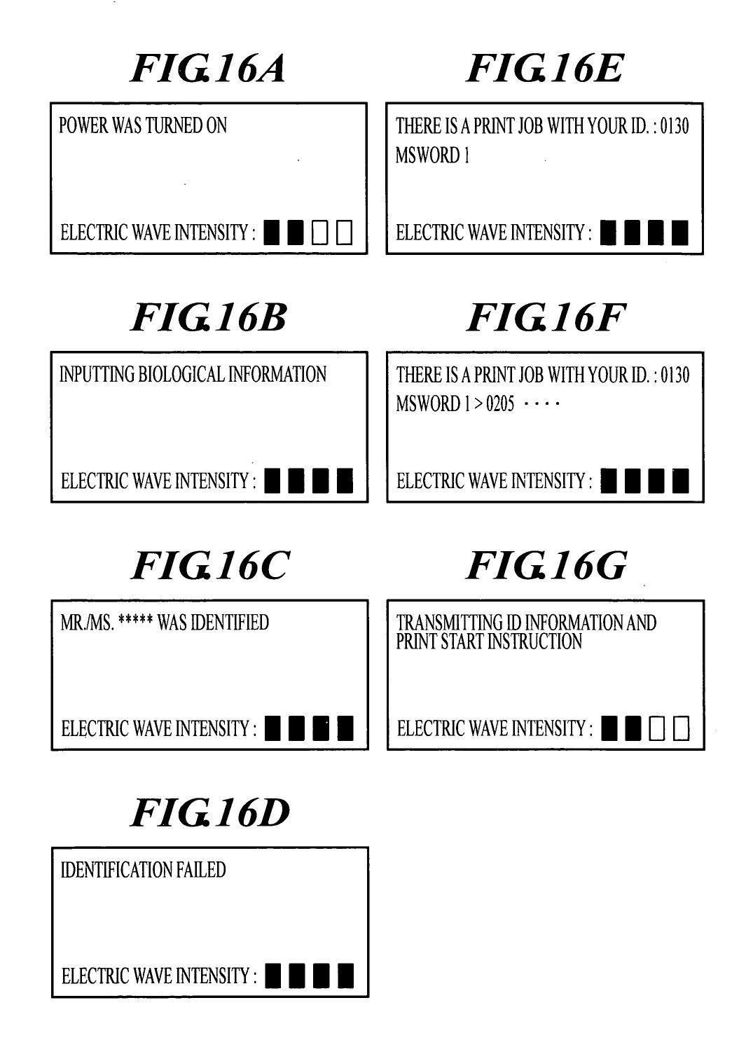

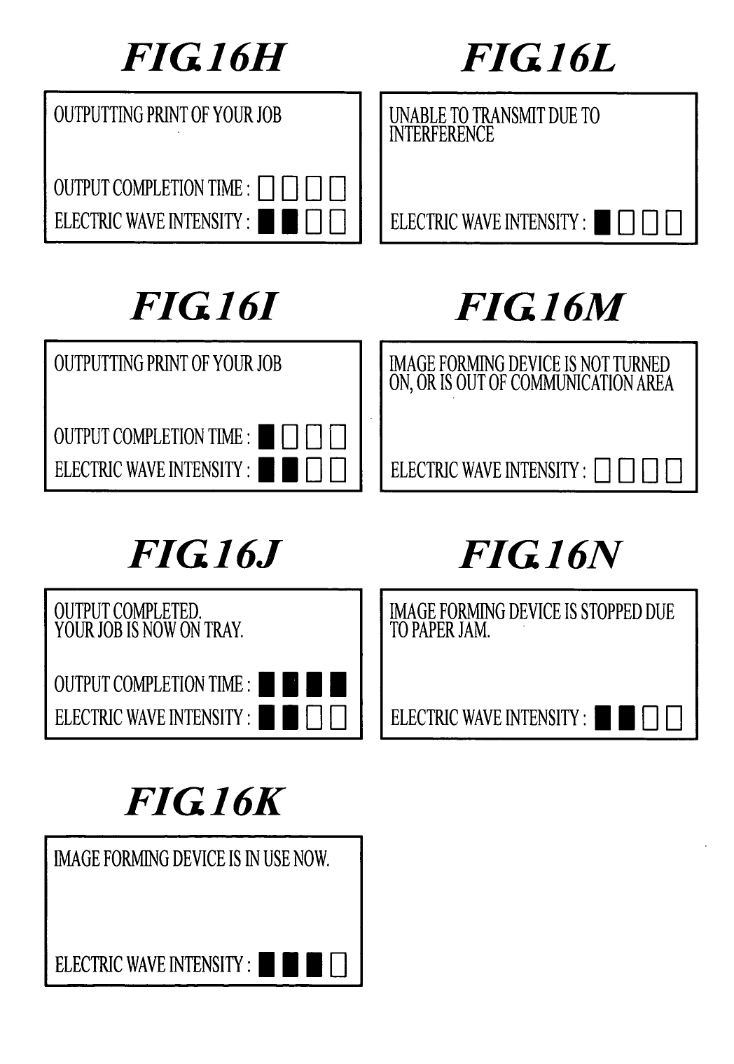

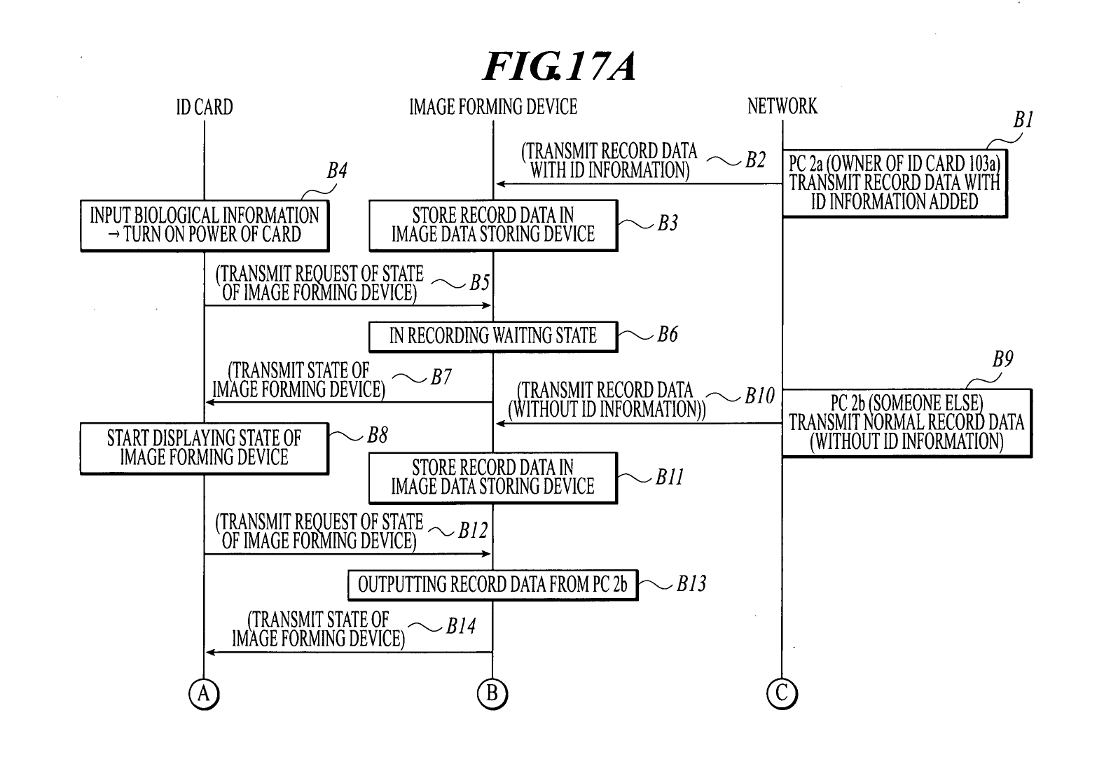

As shown in FIG. 15, when the power of the ID card 103a is OFF, and biological information is inputted from the biological information reading device 136 for performing identification, the power is turned on (Step A1). At this time, on the LCD displaying unit 140 of the ID card 103a, as shown in FIG. 16A, “POWER WAS TURNED ON” Is displayed. Electric wave intensity shown in FIG. 16A indicates intensity of wireless communication electric wave at the location of the ID card 103a, from the image forming device 104.

Next, the biological information reading device 136 re-inputs biological information, and identification is performed (Step A2). While the biological information reading device 136 is reading biological information, as shown in FIG. 16B, “INPUTTING BIOLOGICAL INFORMATION” is displayed on the LCD displaying unit 140 of the ID card 103a. If biological information read by the biological information reading device 136 corresponds to biological information which is in advance stored in the biological information data storing device 137, and the identification is succeeded, as shown in FIG. 16C, “MR./MS. ***** WAS IDENTIFIED.” is displayed on the LCD displaying unit 140, and the buzzer 142 outputs buzzer sound “peep”. If the identification is failed, as shown in FIG. 16D, “IDENTIFICATION FAILED” is displayed on the LCD displaying unit 140.

Continuously, by pushing the operation SW 145 (Step A3), ID information and job list request are transmitted to the image forming device 104 (Step A4). Hereafter, during the communication between the ID card 103a and the image forming device 104, it is assumed that ID information is added to both data transmission from the ID card 103a to the image forming device 104 and data transmission from the image forming device 104 to the ID card 103a, even if there is no such specification.

Then, in the image forming device 104, ID information received from the ID card 103a and ID information being added to record data stored in the image data storing device 161 are verified (Step A5), and a job list of a job to be outputted by the image forming device 104 is transmitted to the ID card 103a (Step A6).

Then, on the LCD displaying unit 140 of the ID card 103a, as shown in FIGS. 16E and 16F, “THERE IS A PRINT JOB WITH YOUR ID.” is displayed as well as the job list (job number, file format, number of pages and the like) is displayed (Step A7). FIG. 16E is an example where there is one job, and the file format “Msword”, the number of page(s) “1” are displayed. Further, if there are a plurality of jobs, as shown in FIG. 16F, the plurality of jobs are displayed with “>” separating the jobs. If display contents are too large to be displayed on the LCD displaying unit 140, part which cannot be displayed is displayed as “ . . . ”. When the image forming device 104 completes outputting the job, the outputted job is deleted from the job list. Here, if the image forming device 104 does not have any job to be outputted, “THERE IS NO JOB.” is displayed on the LCD displaying unit 140.

Next, the biological information reading device 136 inputs biological information, and identification is performed (Step A8). If the identification is succeeded, the identification result is displayed on the LCD displaying unit 140 of the ID card 103a, and the buzzer 142 outputs the buzzer sound “peep”.

Continuously, the biological information reading device 136 inputs biological information for two seconds (Step A9), and ID information and a print start instruction are transmitted to the image forming device 104 (Step A10). At this time, as shown in FIG. 16G, information indicating the transmission state, which is “TRANSMITTING ID INFORMATION AND PRINT START INSTRUCTION” is displayed on the LCD displaying unit 140, and the buzzer 142 outputs buzzer sound “pip pip”.

The image forming device 104 verifies ID information received from the ID card 103a and ID information being added to record data stored in the image data storing device 161, and starts the printing output of the verified record data (Step All). Then, the image forming device 104 transmits information indicating the print start state to the ID card 103a (Step A12).

On the LCD displaying unit 140 of the ID card 103a, as shown in FIG. 16H, information indicating the status of the image forming device 104 is displayed as “OUTPUTTING PRINT OF YOUR JOB” (Step A13).

Next, the ID card 103a transmits an output completion time request to the image forming device 104 (Step A14). The output completion time indicates a status of the job being printed and outputted.

The image forming device 104 calculates the output completion time of the job being printed and outputted (Step A15), and transmits it to the ID card 03a (Step A16).

On the LCD displaying unit 140 of the ID card 103a, information indicating the status of the image forming device 104 is displayed as “OUTPUTTING PRINT OF YOUR JOB” as shown in FIG. 16I, as well as the output completion time is displayed (Step A17). The output completion time is, here, displayed at four levels, and it indicates that approximately 1/4 of the print outputting has been completed.

Until the printing is completed, the ID card 103a transmits the output completion time request to the image forming device 104 a plurality of times (Step A18). When the image forming device 104 completes the printing (Step A19), the image forming device 104 transmits printing completion information to the ID card 103a (Step A20).

On the LCD displaying unit 140 of the ID card 103a, as shown in FIG. 16J, “OUTPUT COMPLETED. YOUR JOB IS NOW ON TRAY.” is displayed for thirty seconds (Step A21). Further, the buzzer 142 outputs buzzer sound “peep” for five seconds.

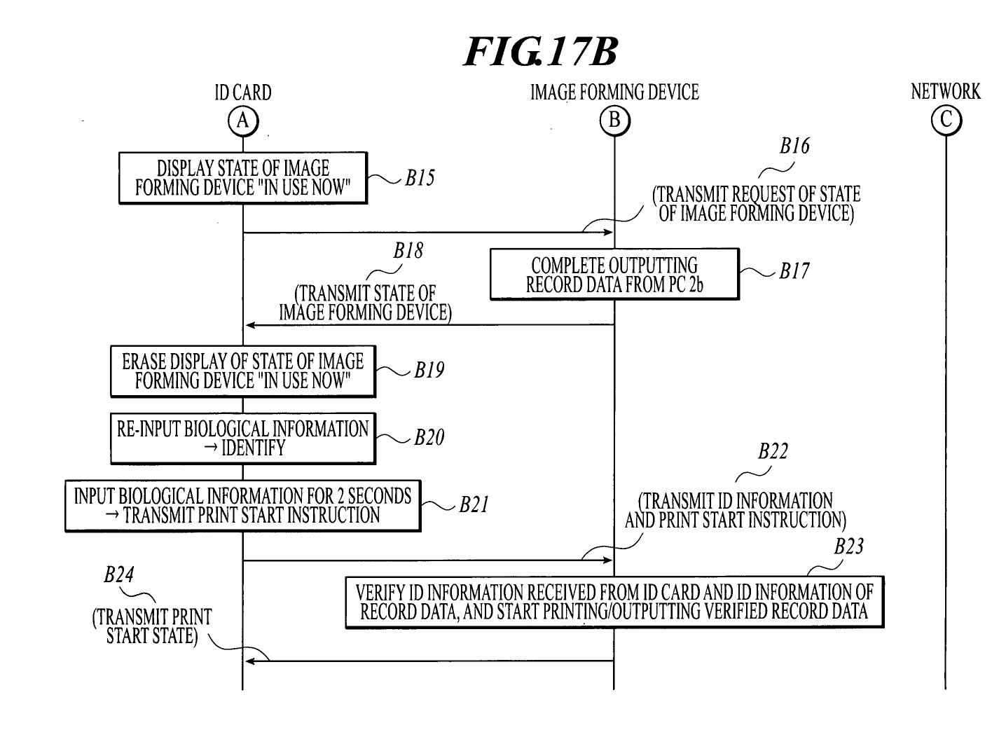

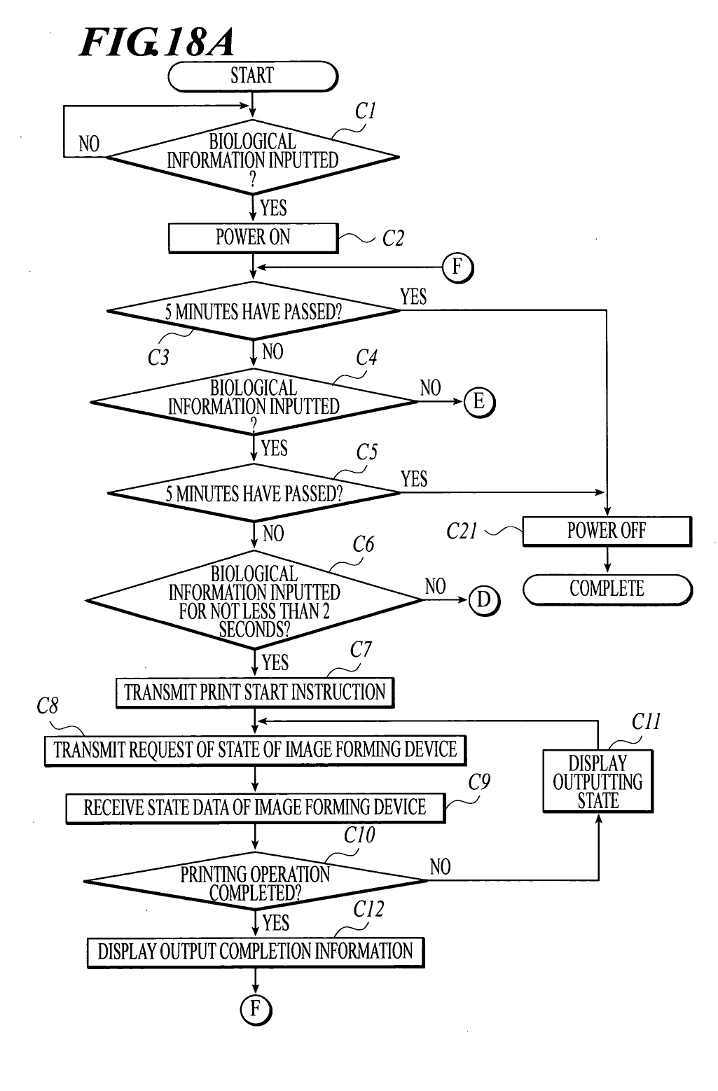

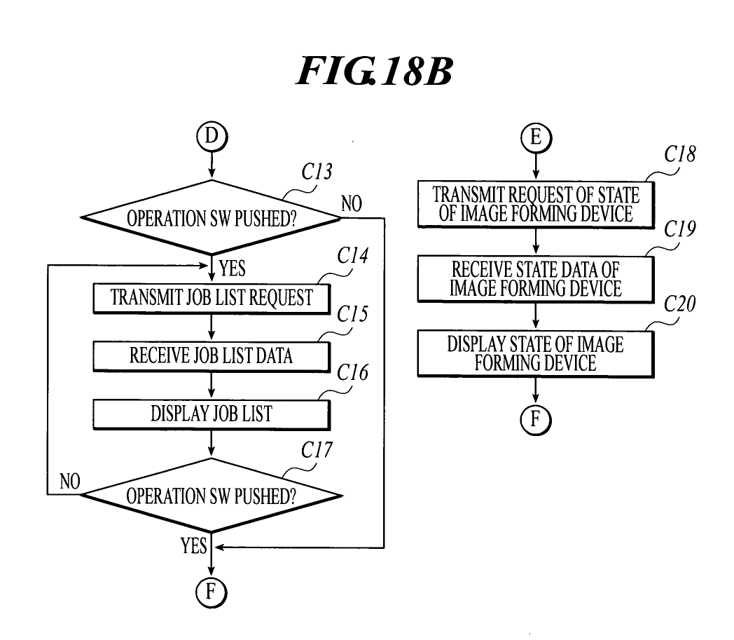

Next, with reference to FIGS. 17A and 17B, in the image outputting system according to the third embodiment, an outline of an operation when a plurality of PCs 2a and 2b transmit record data to the image forming device 104 will be described. Here, it is assumed that an owner of the ID card 103a uses the PC 2a, and someone else uses the PC 2b.

As shown in FIGS. 17A and 17B, the PC 2a transmits record data to which ID information is added to the image forming device 104 through the network N (Step B1, B2). The image forming device 104 stores the received record data in the image data storing device 161 (Step B3).

When the power of the ID card 103a is OFF, and biological information is inputted from the biological information reading device 136 for performing identification, the power is turned on (Step B4). Then, the ID card 103a transmits a request of a state of the image forming device 104 (Step B5).

At this time, the image forming device is in a recording waiting state (Step B6). Then, the image forming device 104 transmits information indicating the state of the image forming device 104 to the ID card 103a (Step B7), and the information indicating the state of the image forming device is displayed on the LCD displaying unit 140 of the ID card 103a (Step B8).

Next, the PC 2b transmits record data to which ID information is not added, to the image forming device 104 through the network N (Step B9, B10). The image forming device 104 stores the received record data in the image storing device 161 (Step B11).

Next, the ID card 103a transmits a request of a state of the image forming device 104, to the image forming device 104 (Step B12). At this time, the image forming device 104 is outputting the image data from the PC 2b (Step B132), and the image forming device 104 transmits information indicating that the image forming device 104 is outputting the record data from the PC 2b, to the ID card 103a (step B14). On the LCD displaying unit 140 of the ID card 103a, as shown in FIG. 16K, information indicating the state of the image forming device 104 is displayed as “IMAGE FORMING DEVICE IS IN USE NOW” (Step B15).

Next, the ID card 103a transmits a request of a state of the image forming device 104, to the image forming device 104 (Step B16). Here, the image forming device 104 completes outputting the record data from the PC 2b (Step B17), and the image forming device 104 transmits the information that the image forming device 104 has completed outputting the record data from the PC 2b, to the ID card 103a (Step B18). Then, the letters “IMAGE FORMING DEVICE IS IN USE NOW” displayed on the LCD displaying unit 140 of the ID card 103a as the state of the image forming device 104 is erased (Step B19).

Next, biological information is inputted at the biological information reading device 136, and identification is performed (Step B20). If the identification is succeeded, the identification result is displayed on the LCD displaying unit 140 of the ID card 103a, as well as the buzzer 42 outputs the buzzer sound “peep”.

Continuously, the biological information is inputted at the biological information reading device 136 for two seconds (step B21), and ID information and a print start instruction are transmitted to the image forming device 104 (Step B22). At this time, on the LCD displaying unit 140, information indicating that ID information and a print start instruction are being transmitted, and the buzzer 142 outputs the buzzer sound “pip pip”.

The image forming device 104 verifies ID information received from the ID card 103a and ID information being added to record data stored in the image data storing device 161, and start outputting print of the verified record data (Step B23). Then, the image forming device 104 transmits information indicating the print start state to the ID card 103a (Step B24).

Here, when the ID card 103a transmits data to the image forming device 104, if another ID card transmits data to the image forming device 104, as shown in FIG. 16L, “UNABLE TO TRANSMIT DUE TO INTERFERENCE” is displayed on the LCD displaying unit 140 of the ID card 103a.

Further, if communication with the image forming device 104 is impossible, as shown in FIG. 16M, “IMAGE FORMING DEVICE IS NOT TURNED ON, OR IS OUT OF COMMUNICATION AREA.” is displayed on the LCD displaying unit 140 of the ID card 103a. Further, according to a state of the image forming device, the state being transmitted from the image forming device 104, if the image forming device 104 is stopped due to paper jam, as shown in FIG. 16N, “IMAGE FORMING DEVICE IS STOPPED DUE TO PAPER JAM.” is displayed. If the image forming device 104 is abnormally stopped, “UNABLE TO PRINT DUE TO MALFUNCTION OCCURS IN IMAGE FORMING DEVICE.” is displayed.

Next, with reference to FIGS. 18A and 18B, a process in the ID card 103a of the third embodiment will be described.

First, when the ID card 103a is in the OFF state, biological information is inputted at the biological information reading device 136 for performing identification (Step C1;YES), the power thereof is turned on (Step C2). In conjunction with turning on the power, the buzzer 142 outputs buzzer sound.

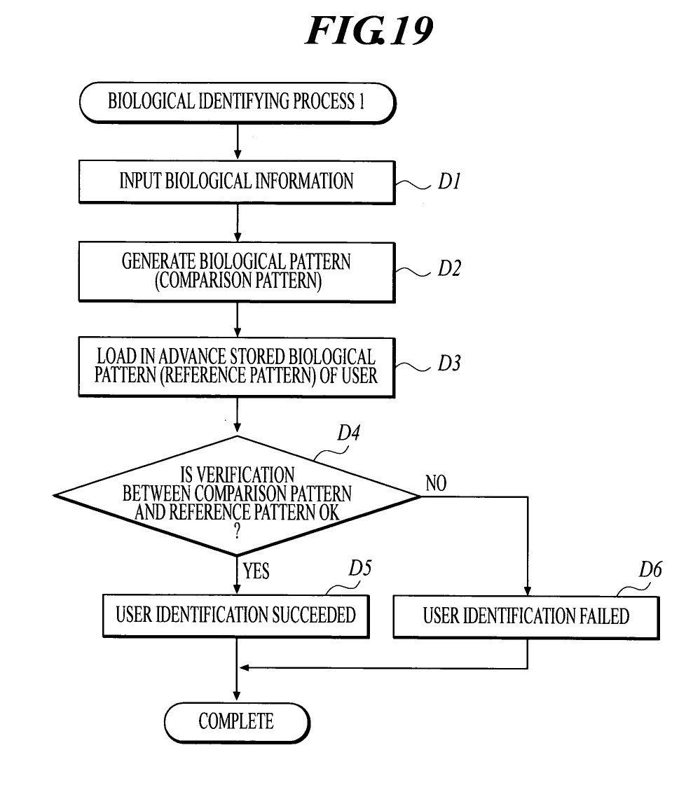

Here, a biological identifying process 1 will be described in detail. As shown in FIG. 19, biological information is inputted at the biological information reading device 136 (Step D1), and a biological pattern (comparison pattern) is generated based on the biological information read by the biological information reading device 136 (Step D2). Next, a biological pattern (reference pattern) of the user which is in advance stored in the biological information data storing device 37 is loaded (Step D3), and the comparison pattern and the reference pattern are verified to each other (Step D4). If the comparison pattern corresponds to the reference pattern (Step D4;YES), identification of the user is succeeded (Step D5). If the comparison pattern does not correspond to the reference pattern (Step D4;NO), identification of the user is regarded as invalid and the process is completed (Step D6).

Back to referring to FIGS. 18A and 18B, the process in the ID card 103a will be described. In this process flow, for power conservation, a waiting process (Step C3, C5) for a predetermined period (for example, five minutes) is set. After the power of the ID card 103a is turned on, within a five minutes period (Step C3;NO), biological information is inputted at the biological information reading device 136 and identification is performed (Step C4;YES), and further within another five minutes period (Step C5;NO), the biological information is inputted at the biological information reading device 136 for not less than two seconds (Step C6;YES), the ID card 103a transmits a print start instruction to the image forming device 104 (Step C7). Here, in Step C3 or Step C5, if the five minutes period has passed without any input made to the operation SW 145 or to the biological information reading device 136 (Step C3;YES, Step C5;YES), the power is turned off (Step C21), and the process is completed. Here, a value of the predetermined period may be set optionally by one minute unit.

After the print start instruction is transmitted to the image forming device 104 (Step C7), the ID card 103a transmits a request of a state of the image forming device 104, to the image forming device 104 (Step C8), and receives the state data of the image forming device 104, from the image forming device 104 (Step C9). Then, if a printing operation of the image forming device 104 has not yet been completed (Step C10;NO), the outputting state of the image forming device 104 is displayed on the LCD displaying unit 140 (Step C11). If the printing operation of the image forming device 104 is completed (Step C10;YES), the buzzer 142 outputs buzzer sound “peep” for five seconds, and information indicating the output completion is displayed on the LCD displaying unit 140 (Step C12). Then, the process returns to Step C3.

In Step C6, if biological information is not inputted at the biological information reading device 136 for not less than two seconds (Step C6;NO), whether the operation SW 145 is pushed or not is judged (Step C13). If the operation SW 145 is pushed (Step C13;YES), a job list request is transmitted to the image forming device 104 (Step C14), and the ID card 103a receives job list data from the image forming device 104 (Step C15). Then, the job list of the image forming device 104 is displayed on the LCD displaying unit 140 (Step C16). Here, until the operation SW 145 is pushed another time (Step C17;YES), processes of Step 14 to Step C16 are repeated. If the operation SW 145 is pushed again (Step C17;YES), the process returns to Step C3.

In Step C4, if biological information is not inputted at the biological information reading device 136 (Step C4;NO), the ID card 103a transmits the request of a state of the image forming device 104, to the image forming device 104 (Step C18), and the ID card 103a receives state data of the image forming device 104, from the image forming device 104 (Step C19). Then, information indicating the state of the image forming device 104 is displayed on the LCD displaying unit 140 (Step C20), and the process returns to Step C3.

According to the image outputting system in the third embodiment, when biological information is inputted at the biological information reading device 136 for two seconds, the ID card 103a transmits ID information. Thereby, it is possible to transmit ID information according to user's demand. Further, if the user is identified as himself/herself based on biological information, ID information is transmitted. Therefore, it is possible to prevent others than a user himself/herself from using the system, illicitly.

Further, the ID card 103a is capable of displaying information indicating the transmission state of ID information and information indicating the output state of record data in the image forming device 104, to inform a user. Therefore, it is possible for a user to recognize information indicating the transmission state of ID information and information indicating the output state of record data in the image forming device 104.

Here, if the ID card 103a comprises a sound generating section such as a speaker or the like, information indicating the transmission state of ID information and information indicating the output state in the image forming device 104 may be informed of with sound. As the information indicating the transmission state of ID information, for example, “TRANSMITTING ID INFORMATION”, “UNABLE TO TRANSMIT NOW” or the like are informed of with sound. Further, as the information indicating the output state of record data in the image forming device 104, for example, “PRINTING NOW”, “WAITING FOR PRINTING”, “PRINTING COMPLETED” or the like are informed of with sound.

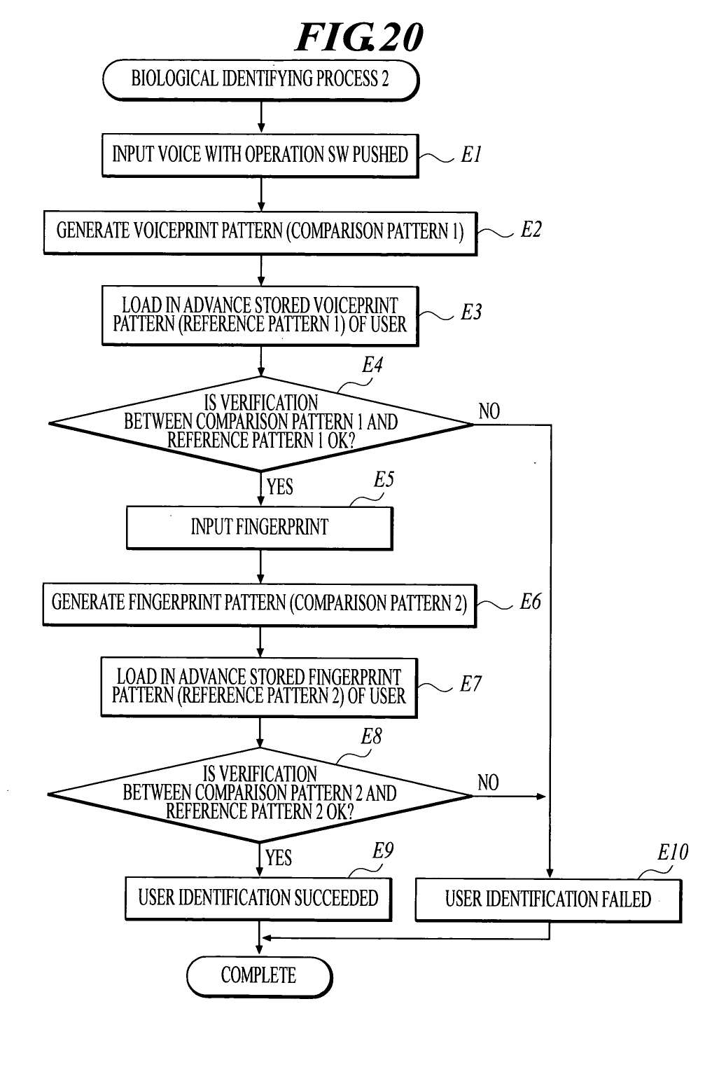

Further, for identifying a user based on biological information, a plurality of pieces of biological information may be used. With reference to FIG. 20, a biological identifying process 2 using a plurality of pieces of biological information will be described.

As shown in FIG. 20, first, while the operation SW 145 is being pushed down, voice of a user is inputted from the microphone 144 (Step E1), and a voiceprint pattern (comparison pattern 1) is generated based on the inputted voice information (Step E2). Next, a voiceprint pattern of the user (reference pattern 1) which in advance is stored in the biological information data storing device 137 is loaded (Step E3), and the comparison pattern 1 and the reference pattern 1 are verified to each other (Step E4).

If the comparison pattern 1 corresponds to the reference pattern 1 (Step E4;YES), fingerprint information is inputted at the biological information reading device 136 (Step E5), and a fingerprint pattern (comparison pattern 2) is generated based on the fingerprint information read by the biological information reading device 136 (Step E6). Next, a fingerprint pattern of the user (reference pattern 2) which in advance stored in the biological information data storing device 137 is loaded (Step E7), and the comparison pattern 2 and the reference pattern 2 are verified to each other (Step E8). If the comparison pattern 2 corresponds to the reference pattern 2 (Step E8;YES), identification of the user is succeeded (Step E9). If the comparison pattern 1 does not correspond to the reference pattern 1 (Step E4;NO), or if the comparison pattern 2 does not correspond to the reference pattern 2 (Step E8;NO), identification of the user is regarded as invalid, and the process is completed (Step E10). With combination of a plurality of pieces of biological information, it is possible to perform user identification more accurately.

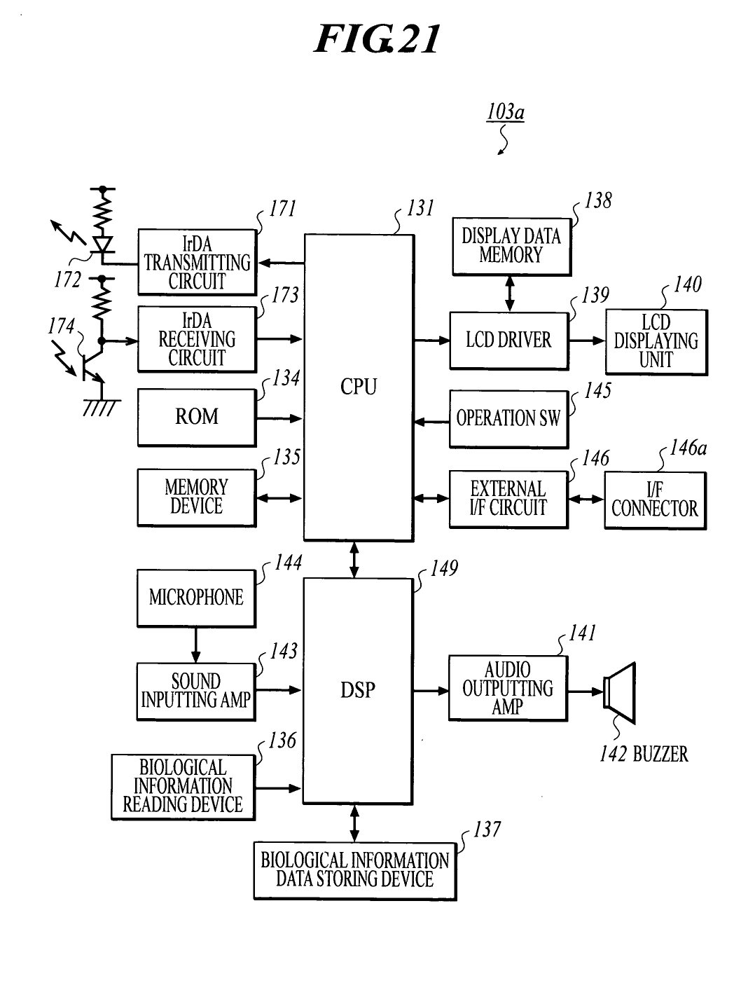

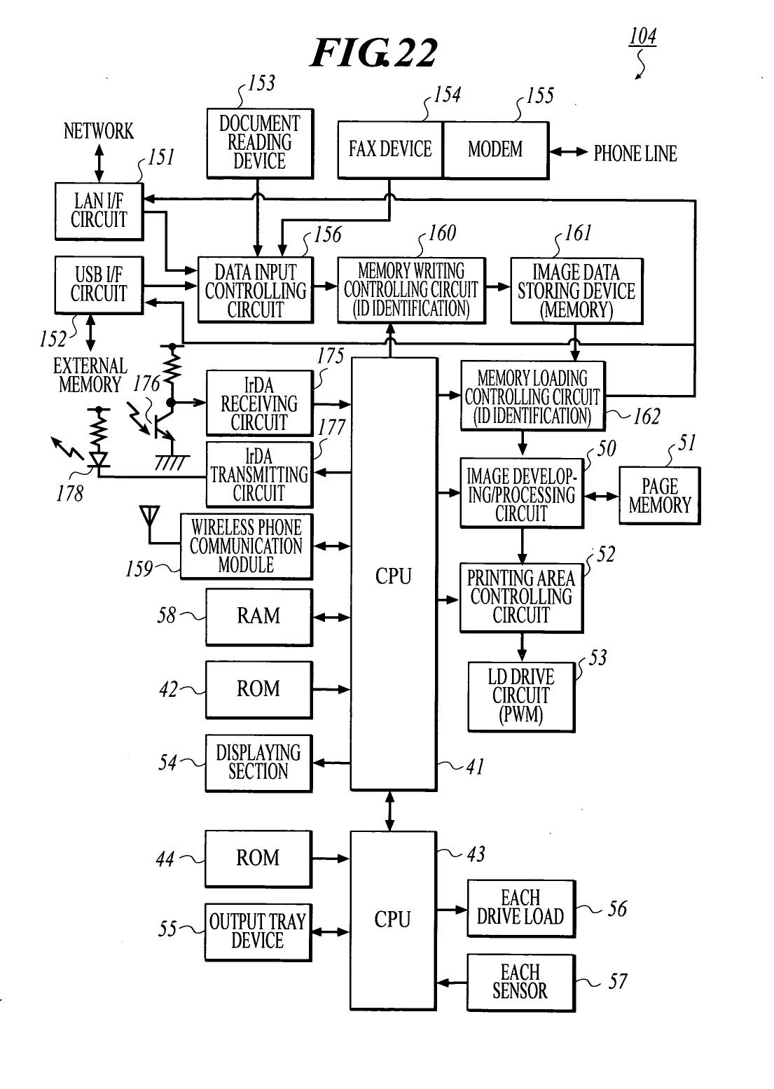

Further, for data communication between the ID card 103a and the image forming device 104, the IrDA method may be used. In this case, the ID card 103a comprises, instead of the wireless data transmitting circuit 132 and the wireless data receiving circuit 133 shown in FIG. 13, an IrDA transmitting circuit 171, an infrared ray emitting LED 172, an IrDA receiving circuit 173 and a phototransistor 174 as shown in FIG. 21. Since the other component parts are approximately the same as those of the ID card 103a shown in FIG. 13, identical numeral is added to them, and description thereof is omitted. The IrDA transmitting circuit 171 drives the infrared ray emitting LED 172 to emit infrared rays for transmitting data. The IrDA receiving circuit 173 receives data by receiving infrared rays at the phototransistor 174. Similarly, the image forming device 104 comprises, instead of the wireless data receiving circuit 157 and the wireless data transmitting circuit 158 shown in FIG. 14, an IrDA receiving circuit 175, a phototransistor 176, an IrDA transmitting circuit 177 and an infrared ray emitting LED 178. Since the other component parts are approximately the same as those of the image forming device 104 shown in FIG. 14, identical numeral is added to those component parts, and description thereof is omitted. The IrDA receiving circuit 175 receives data by receiving infrared rays at the phototransistor 176. The IrDA transmitting circuit 177 drives the infrared ray emitting LED 178 to emit infrared rays for transmitting data.

Further, in the third embodiment, described is the case that biological information is inputted at the biological information reading device 136 for two seconds, and the ID card 103a transmits ID information. However, an ID information transmitting instruction may be inputted from the operation SW 145. Also in this case, it is possible to transmit ID information according to user's demand.

Further, in the third embodiment, described is the case that the biological identification result, the transmission state of the ID card 103a and the output state of the image forming device 104 are informed of with the display on the LCD displaying unit 140, the buzzer sound by the buzzer 142 and the sound by the speaker. However, with the ID card 103a comprising a vibration function, the biological identification result, the transmission state of the ID card 103a and the output state of the image forming device 104 may be informed of with vibration of the ID card 103a.

Further, in the ID card 103a, instead of displaying the output completion time indicating a status of a job being printed and outputted, remaining time to printing completion may be displayed.

[Alternative Example]

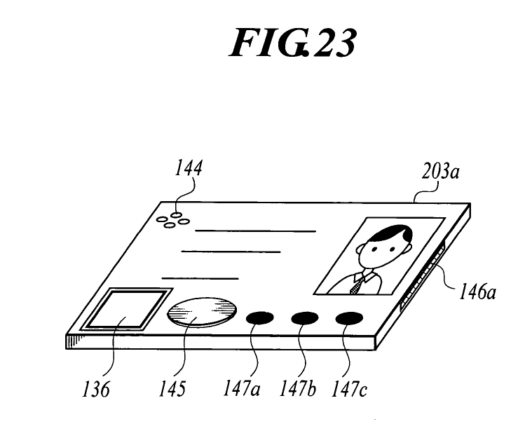

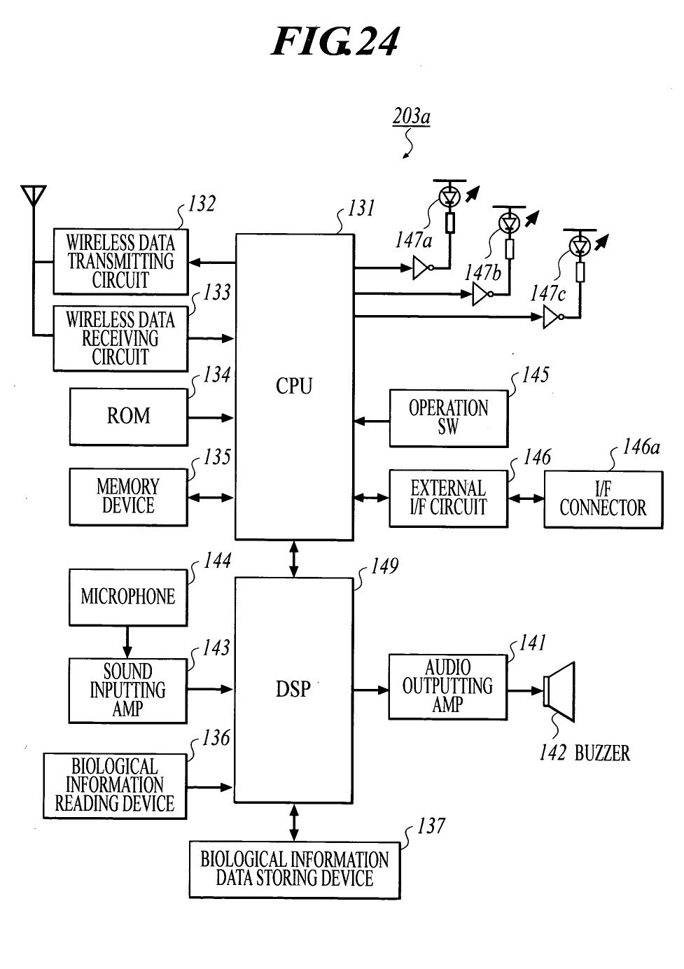

With reference to FIGS. 23 and 24, an alternative example of the third embodiment will be described.

FIG. 23 shows an external structure of an ID card 203a in an image outputting system of the alternative example. As shown in FIG. 23, on the surface of the ID card 203a, owner's facial portrait, name and the like are printed, and a state display LEDs 147a, 147b, 147c, the operation SW 145, the biological information reading device 136 and the microphone 144 are provided.

FIG. 24 shows a functional structure of the ID card 203a. As shown in FIG. 24, the ID card 203a comprises the CPU 131, the wireless data transmitting circuit 132, the wireless data receiving circuit 133, the ROM 134, the memory device 135, the biological information reading device 136, the biological information data storing device 137, the state display LEDs 147a, 147b, 147c, the audio outputting AMP 141, the buzzer 142, the sound inputting AMP 143, the microphone 144, the operation SW 145, the external I/F circuit 146 and the DSP 149.

If it is necessary to have only minimal functions, the ID card 203a may not comprise the audio outputting AMP 141, the buzzer 142, the sound inputting AMP 143 and the microphone 144. Further, if it is necessary to rewrite data stored in the ID card 203a with the use of a wireless communication function of the ID card 203a, the ID card 203a may not comprise the external I/F circuit 146.

In the alternative example, since-component parts other than parts characteristic to the alternative example are approximately the same as those of the image outputting system in the third embodiment, identical numeral is added to the identical component parts, and description thereof is omitted.

In the third embodiment, the ID card 103a comprises the LCD displaying unit 140, which displays information indicating the biological identification result and information indicating the output state of the image forming device 104. However, in the alternative example, the ID card 203a displays the biological identification result, the output state of the image forming device 104 and the like by turning on or blinking the state display LEDs 147a, 147b, 147c.

The state display LED 147a is turned on when there is a print job to which ID information of the owner of the ID card 203a is added, in the image forming device 104. It is turned off when the job is completed.

The state display LED 147b is blinking while the image forming device 104 is outputting print, and when the output is completed, it is kept on for 30 seconds. Time interval of the blinking of the state display LED 147b may be made shorter according to the progress of a job being printed and outputted in the image forming device 104.

The state display LED 147c is turned on at the time that the biological information reading device 136 has read biological information and has performed identification.

Also in the ID card 203a of the alternative example, it is possible to inform a user of the biological identification result, the output state of the image forming device 104 and the like.

[Fourth Embodiment]

Next, a fourth embodiment to which the present invention is applied will be described.

An image outputting system is structured to be capable of using a PDA-(Personal Digital Assistant) 303a equipped with (or optionally being equippable with) a wireless communication function as a transmitting device, instead of the ID card 103a in the third embodiment. Since the other component parts are approximately the same as those of the third embodiment, identical numeral is added to the identical component parts, and illustration and description thereof are omitted. Hereinafter, a structure characteristic to the fourth embodiment will be described.

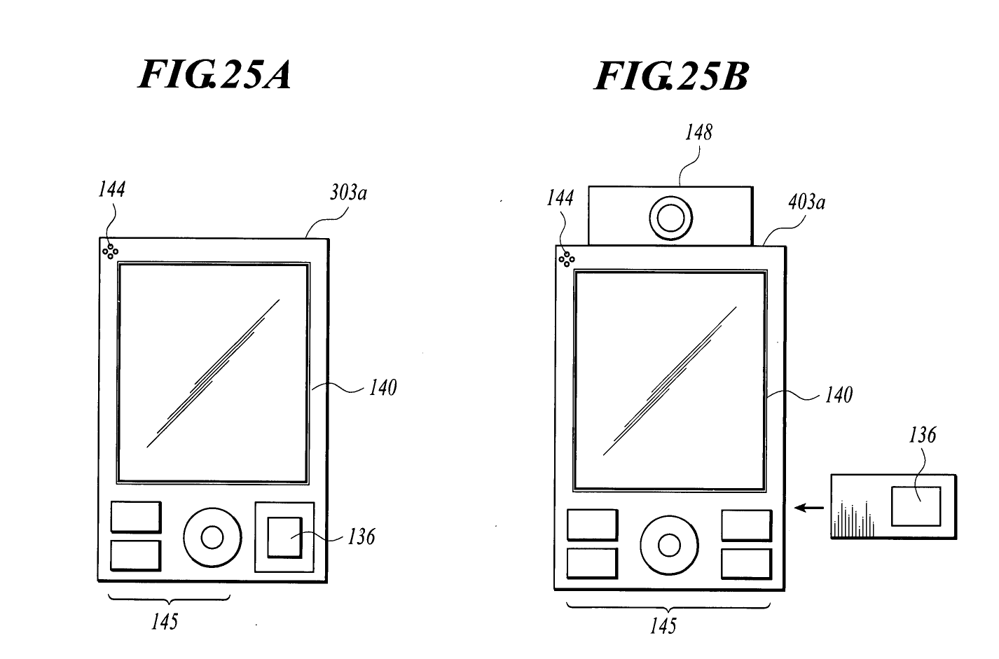

FIG. 25A shows an external structure of the PDA 303a. As shown in FIG. 25A, the PDA 303a comprises the LCD displaying unit 140, the operation SW 145, the biological information reading device 136 and the microphone 144. Further, a touch panel is provided so as to cover the display screen of the LCD displaying unit 140. Since a functional structure of the PDA 303a is approximately the same as that of the ID card 103a shown in FIG. 13, identical numeral is added to the identical component parts, and illustration and description thereof are omitted. Fingerprint identification may be performed based on sound inputted from the microphone 144.

Further as shown in FIG. 25B, a PDA 403a comprising a camera 148 for face identification or retina identification may be used. If the PDA 403a itself does not comprise a device for reading biological information, separately-provided biological information reading device 136 may be connected with the USB or the SD I/O module.

If fingerprint is used as the biological information, the biological information reading device 136 reads a pattern of fingerprint of a finger of the owner, based on a change in resistance of the finger being contacted with a semiconductor electrode, or a difference of electric charge between peaks and troughs occurred according to the pushed finger.

If a minutiae of a face is used as the biological information, the biological information reading device 136 extracts minutiae of facial parts such as eyes, nose, eyebrow and the like and quantifies relative positions of the minutiae for reading a pattern of the face.

If a retina is used as the biological information, the biological information reading device 136 reads a pattern of capillary in the retina of eyes. If an iris is used as the biological information, the biological information reading device 136 reads a pattern of the iris.

If a vein of a finger, a palm or the back of a hand is used as the biological information, the biological information reading device 136 extracts a vein pattern by irradiating near infrared rays from a near infrared rays LED toward a targeted region, reading the transmitted light intensity at a CCD (Charge Coupled Device) and applying an image process.

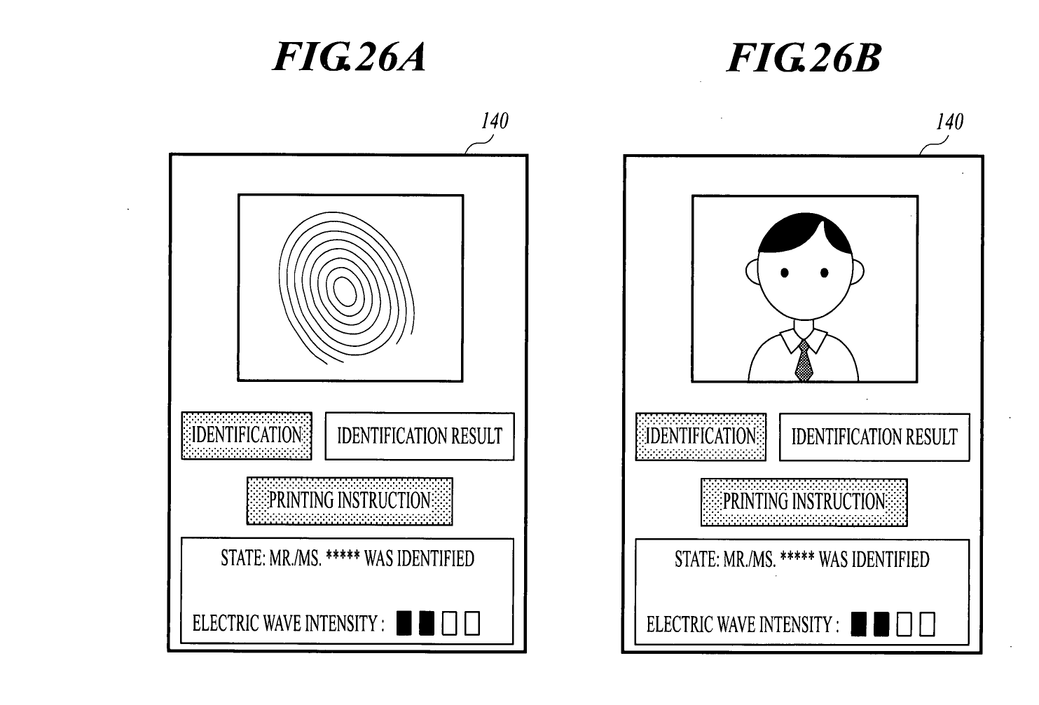

FIG. 26A shows a display example on the LCD displaying unit 140 of the PDA 303a. If the biological information reading device 136 is used for fingerprint identification, the biological information reading device 136 reads fingerprint of the owner of the PDA 303a, and performs identification. Then, as shown in FIG. 26A, an image of the fingerprint read by the biological information reading device 136 and the identification result “MR./MS. ***** WAS IDENTIFIED.” are displayed.

FIG. 26B shows a display example of facial identification on the LCD displaying unit 140 of the PDA 403a. When facial identification is performed by photographing a face of the owner of the PDA 403a with the camera 148, as shown in FIG. 26B, a facial image photographed with the camera 148 and the identification result “MR./MS. ***** WAS IDENTIFIED.” are displayed.

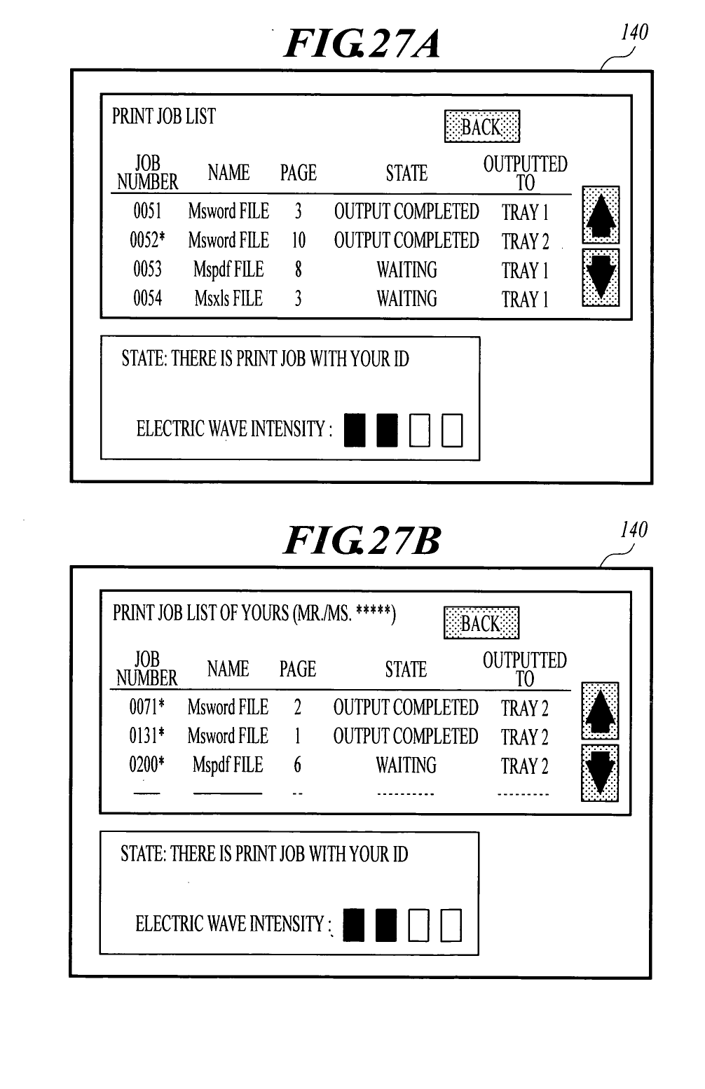

FIGS. 27A and 27B show examples of a print job list of the image forming device 104 displayed on the LCD displaying unit 140 of the PDA 303a. FIG. 27A is a list of all the print jobs to be outputted by the image forming device 104, and FIG. 27B is a list of the print jobs of the owner of the PDA 303a to be outputted by the image forming device 104. As shown in FIGS. 27A and 27B, displayed are each job's job number, file format, number of pages, output state, tray to be outputted and the like. Here, “*” beside the job number indicates that it is record data to which ID information is added. The list display of all the print jobs and the list display of the print jobs of the owner of the PDA 303a may be switchable by making a switching instruction at the operation SW 145 of the PDA 303a or on the touch panel of the LCD displaying unit 140.

According to the image outputting system in the fourth embodiment, by using the PDA 303a as the transmitting device, it is possible to display the biological identification result and the output state of the image forming device 104 in more detail.

Here, in the fourth embodiment, described is the case of using a PDA as the transmitting device. However, a cellular phone or a mobile PC comprising a wireless communication function may be used, instead. By using a PDA, a cellular phone or a mobile PC, it is possible to provide a biological information reading device 136 for reading face, retina, iris, vein or the like, which had been difficult to be realized in an ID card type transmitting device.

[Fifth Embodiment]

Next, a fifth embodiment to which the present invention is applied will be described with reference to figures.

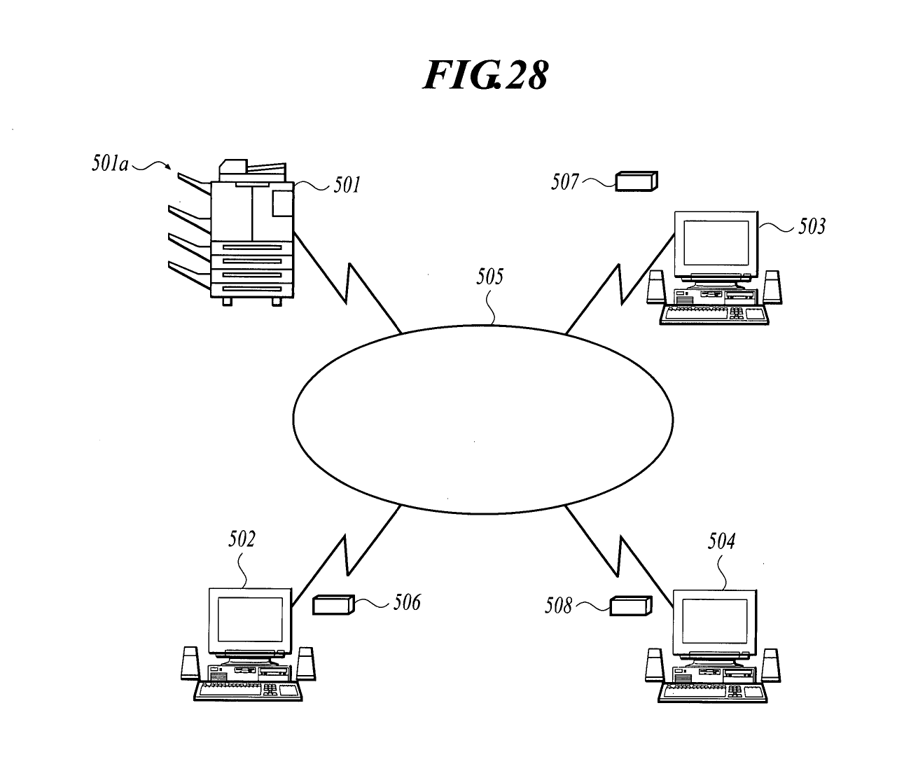

FIG. 28 is a block diagram showing a system structure of an image outputting system in the fifth embodiment.

In the present embodiment, description will be made by citing a digital copying machine with a network printer function (hereafter, it is referred to as a digital copying machine) as an example of the image forming device, a personal computer as an example of the network terminal, and a portable terminal device as an example of the transmitting device. Further, a user who instructs the image formation to the digital copying machine by operating the personal computer is assumed to carry the portable terminal device. This portable terminal device may be, for example, a PDA, a cellular phone or the like, or it may be an IC card equipped with a function which will be explained later.

As shown in FIG. 28, the image outputting system according to the present embodiment is structured so as to connect a digital copying machine 501 to personal computers 502 to 504 through a network 505, and further, the image outputting system comprises portable terminal devices 506 to 508 each carried by a respective operator of the personal computers 502 to 504.

The digital copying machine 501 is capable of reading (scanning) a document and forming an image (printing) by itself, and additionally, the digital copying machine 501 is capable of transmitting an read image to another device through the network 505, and is capable of forming the image received from another device through the network 505. The digital copying machine 501 comprises an output tray, for outputting paper on which image is formed, that is, printed paper. In the present embodiment, an output tray 501a is provided as a dedicated tray for outputting paper on which record data with ID information is printed (will be described later).

Further, the image outputting system in the present embodiment is structured so as to connect the personal computers 502 to 504 to the network 505. Each of the personal computers 502 to 504 is capable of using the image forming device, that is, the digital copying machine 501 as a remotely-connected printer. By transmitting record data to the digital copying machine 501 from the personal computers 502 to 504, it is possible to perform the printing by an image forming section of the digital copying machine 501 based on the record data.

In FIG. 28, the network 505 may be any type of network including LAN, such as Ethernet (Trademark), token ring or the like, Internet and others. To each device connected to the network 505, an address on the network (for example, ID address) is set in advance, and each device is identified with the address for communicating with other devices connected to the network 505. Such communication may be done by the so-called e-mail, or it may be done according to any such as ftp protocol, http protocol or the like.

Here, in FIG. 28, numerical relation between the personal computer (network terminal) and the digital copying machine (image forming device) is plural to one. However, needless to say, it may be plural to plural.

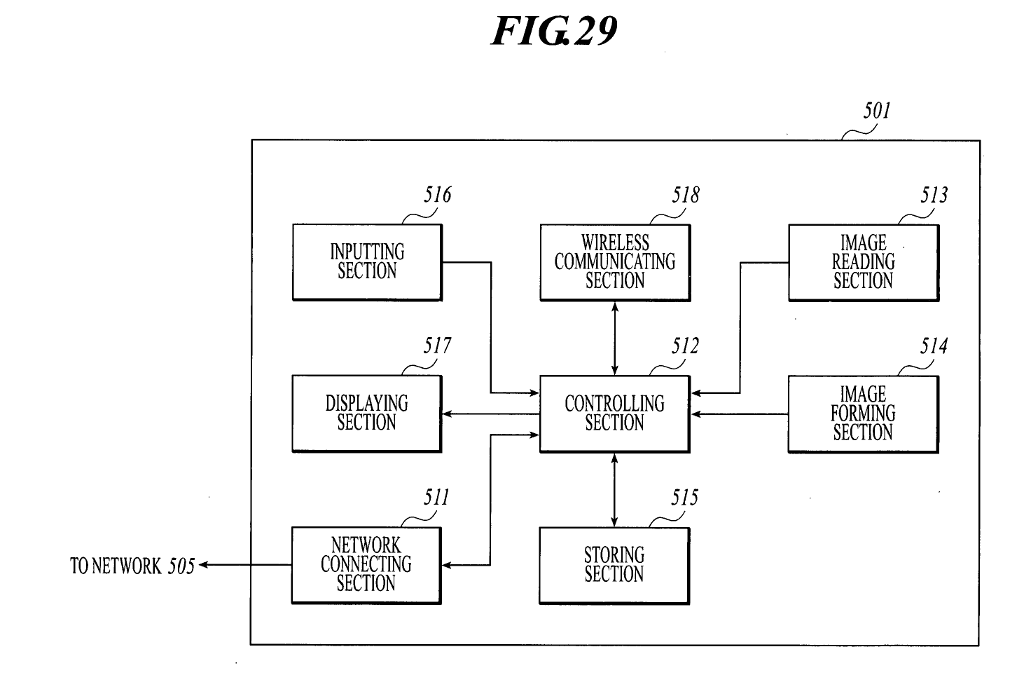

FIG. 29 is a block diagram showing a structure of the digital copying machine 501 shown in FIG. 28.

The digital copying machine 501 comprises a network connecting section 511 which is an interface to the network 505 shown in FIG. 28, a controlling section 512 for controlling all the operations (including various types of controls, which will be described later) of the digital copying machine 501, an image reading section 513 for reading an image from a document, an image forming section 514 for forming an image on, for example, paper or the like, an storing section for storing image data read by the image reading section 513, parameters and 501, software programs (including various types of control programs operated by the controlling section 512, which will be described later) necessary for the operation of the digital copying machine 501, an inputting section for a user to input an operation, an instruction and the like to the digital copying machine 501, a displaying section 517 for displaying various types of information to the user, and a wireless communicating section 518 for wirelessly communicating with the portable terminal devices 506 to 508.

The wireless communicating section 518 is simply capable of communicating with the portable terminal devices 506 to 508 at a single frequency, and for example, the communication thereof may be done with electric wave, infrared rays or the like. Its communication protocol may be any such as IrDA, Bluetooth or the like, as long as it is capable of transmitting and receiving.

Here, the inputting section 516 and the displaying section 517 may be integrated to provide an operation screen such as a touch panel or the like.

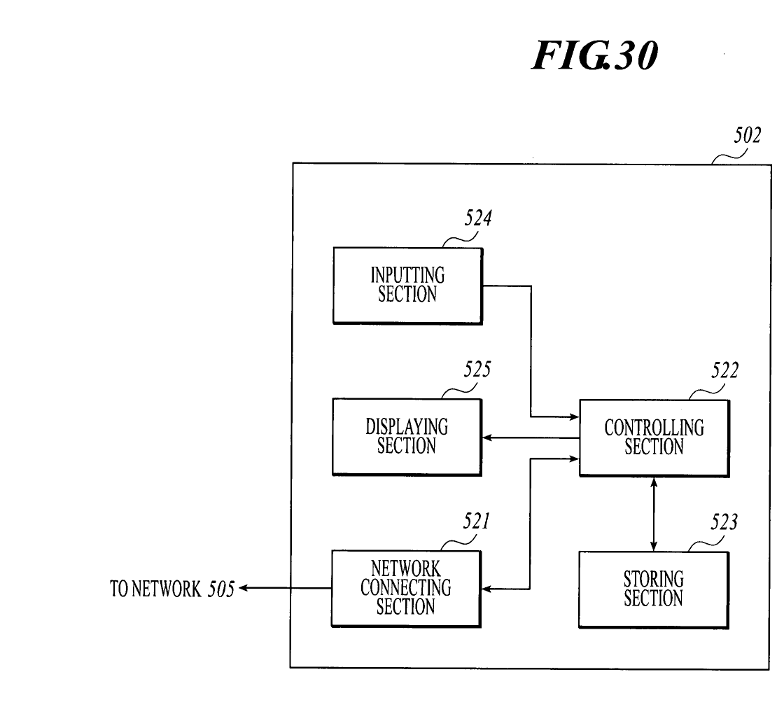

FIG. 30 is a block diagram showing a structure of the personal computer 50 shown in FIG. 28.

Since the personal computers 502 to 504 shown in FIG. 30 have the same fundamental structures according to the present embodiment, here, the personal computer 502 will be described on behalf of them.

The personal computer 502 comprises a network connecting section 521 which is an interface to the network 505 shown in FIG. 28, a controlling section 522 for controlling the entire operation thereof, a storing section 523 for storing parameters, software programs and the like necessary for the operation thereof, an inputting section 524 for an operator thereof to input an operation, an instruction and the like to the personal computer 502, and a displaying section 525 for displaying various types of information to the operator thereof.

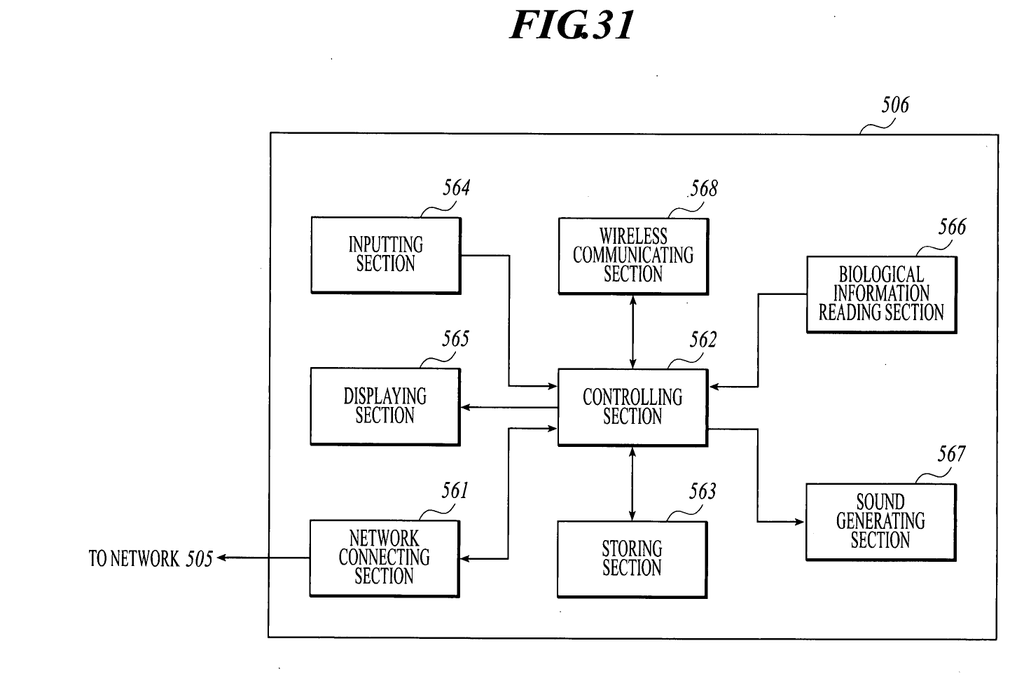

FIG. 31 is a block diagram showing a structure of the portable terminal device 506 shown in FIG. 28.

Since the portable terminal 506 to 508 have approximately the same fundamental structure according to the present embodiment, here, the portable terminal 506 will be described on behalf of them.

The portable terminal device 506 comprises a network connecting section 561 which is an interface to the network 505 shown in FIG. 28, a controlling section 562 for controlling the entire operation thereof, a storing section 563 for storing parameters, software programs and the like necessary for the operation thereof, an inputting section 564 for an operator thereof to input an operation, an instruction and the like to the portable terminal device 506, a displaying section 565 for displaying various types of information to the operator thereof, a sound generating section 567 for generating sound to the operator, and a wireless communicating section 568 for wirelessly communicating with the digital copying machine 501. Here, The inputting section 564 and the displaying section 564 are not necessary in view of fundamental functions required to the portable terminal device 506.

The wireless communicating section 568 may be capable of wirelessly communicating with the digital copying machine 501 at a single frequency, for example, the communication may be done with electric wave, infrared rays or the like. Its communication protocol may be in any shape as long as it is capable of transmitting and receiving, such as IrDA, Bluetooth or the like.

Here, if a plurality of portable terminal devices are to wirelessly communicate with the digital copying machine 501 simultaneously, although there is a possibility of interference in the case that all the plurality of portable terminal devices use the same frequency, in the image outputting system in the present embodiment, it is possible to perform a control (will be described later) so as to avoid the interference even in the case of the simple communication with a single frequency. Thereby, the present invention creates the effect that each device structure can be easily made with low cost.

Next, an operation of the image outputting system according to the present embodiment will be described.

Here, in the following description, it is assumed that a user A operates the personal computer 502 shown in FIG. 28 and carries the portable terminal device 506, a user B operates the personal computer 503 and carries the portable terminal device 507, and a user C operates the personal computer 504 and carries the portable terminal device 508.

Further, here, an operation in the case that the user A uses the digital copying machine 501 for performing the printing will be described.

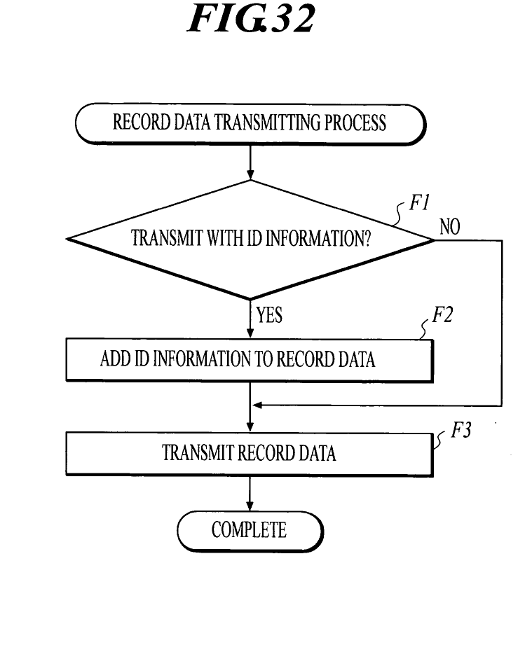

FIG. 32 is a flowchart illustrating a record data transmitting process which is a process in the personal computer 502 at the time that the personal computer 502 instructs the printing to the digital copying machine 501, in the operation of the image outputting system according to the present embodiment.

First, the user A operates the inputting section 524 of the personal computer 502 for instructing to select record data, instructing whether the printing is to be performed with ID information, and instructing the printing. Based on the input from the inputting section 524, the controlling section 522 specifies record data, and determines whether to print it with ID information, that is, whether to transmit it with ID information to the digital copying machine 501 or not (Step F1).

Here, the phrase “with ID information” will be explained.

The image outputting system according to the present embodiment is provided so as to enable a user to select whether “to instruct the printing with ID information” or “to instruct the printing without ID information” with, for example, the inputting section of the personal computer 502 (this is an printing method selecting section for allowing a user to select whether to use a with-ID-information record data transmitting section or to use a without-ID-information record data transmitting section, at the time of transmitting the record data to be printed in the image forming device, to the image forming device). However, the image outputting system may be provided so that a user always selects “to instruct the printing with ID information”.

In other words, when a user instructs the printing with the inputting section 524 of the personal computer 502, the personal computer 502 transmits the record data as-is to the digital copying machine 501 through the network connecting section 521 and the network 505 (this is the without-ID-information record data transmitting section for transmitting only record data without adding ID information), and the digital copying machine 501 receives it through the network 505 and the network connecting section 511 (this is a without-ID-information record data receiving section for receiving the record data transmitted from a without-ID-information record data transmitting section). Then, the controlling section 512 of the digital copying machine 501 makes the image forming section 514 start the printing of the received record data after other printings that are either being printed or being in a waiting state (this is a printing without ID information starting section for starting the printing with the image forming section based on received record data when the without-ID-information record data receiving section receives the record data without ID information).

On the other hand, if a user selects “to instruct the printing with ID information”, an operation is performed so that “while security is made improved so as to prevent printed material by the image forming device from being exposed to other people's eyes against the will of a person who has instructed the printing, waiting time of such a person beside the image forming device is reduced and inconvenience on the operation does not occur even if there are a plurality of users near the image forming device”. This operation will be described later in detail.

Here, “ID information” means information uniquely allocated to each user of the image outputting system, and it may be in any shape, such as a number, a character string or the like. The ID information is in advance set to each user, and stored in a storing section of the personal computer and the portable terminal device used by the user. For example, ID information of the user A is in advance stored in the storing section 523 of the personal computer 502 and in the storing section 562 of the portable terminal device 506, and the controlling section 522 or the controlling section 562 loads the ID information according to necessity.

Back to the description of FIG. 32, if “to instruct the printing without ID information” is selected “Step F1;NO), the process proceeds to Step F3 and the controlling section 522 transmits the assigned data to the digital copying machine 501 through the network connecting section 521 and the network 505. On the other hand, if “to instruct the printing with ID information” is selected (Step F1;YES), the controlling section 522 loads ID information of the user A from the storing section 523, adds the loaded ID information to the assigned record data (Step F2), and transmits the “record data with ID information” to the digital copying machine 501 through the network connecting section 521 and the network 505. This is the with-ID-information record data transmitting section for transmitting record data with ID information stored in the storing section of the network terminal added at the time of transmitting the record data to be printed in the image forming device, to the image forming device.

Continuously, an operation of the image outputting system at the step that a user A having done the printing instruction to the digital copying machine 501 is approaching the digital copying machine 501 in order to obtain the printed material will be described.

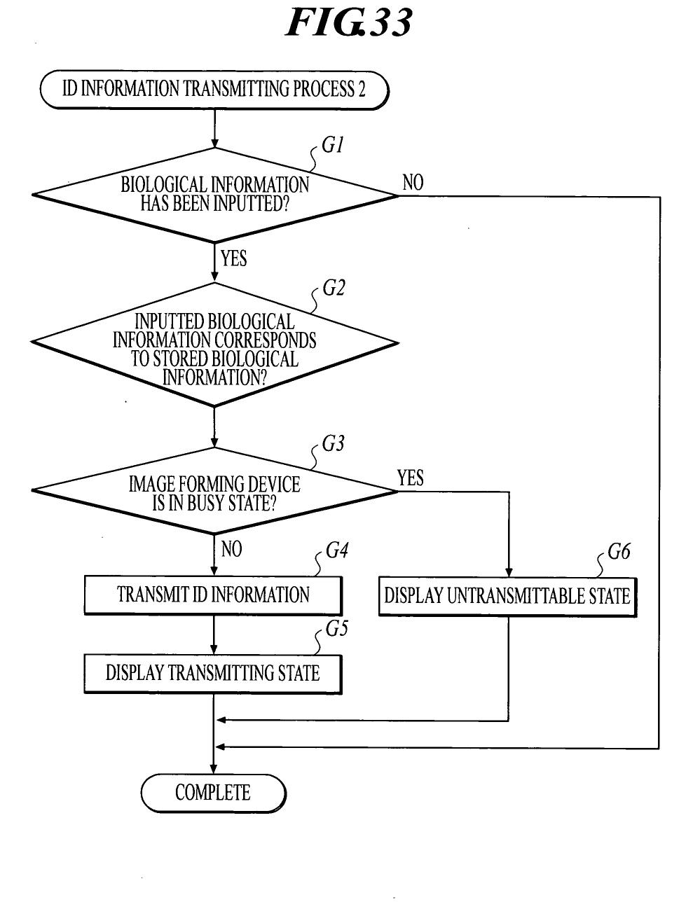

FIG. 33 is a flowchart illustrating an ID information transmitting process 2 which is a process performed by the portable terminal device 506 that the user A carries, in the operations of the image outputting system according to the present embodiment.

If a user A selects “to instruct the printing with ID information”, he/she inputs his/her biological information with the biological information reading section 566 of the portable terminal device 506 that he/she carries. The biological information in this situation means information with which it is possible to identify each individual, such as fingerprint, iris and the like. Therefore, the biological information reading section 566 is, for example, fingerprint reading device or the like, and a structure of the fingerprint reading device or the like may be conventionally well-known one. This is the biological information reading section for reading biological information inputted by a user.

Further, instead of the biological information reading device 566, a method of inputting an password for identifying each user may be used.

The controlling section 562 of the portable terminal 506 monitors to see whether there is an input of biological information by the biological information reading section 566 (Step G1), and if there is an input of biological information (Step G1;YES), the controlling section 562 starts the process.

The storing section 563 of the portable terminal device 506 stores in advance biological information of the user A that uses the portable terminal device 506, and the controlling section 562 loads it and determines whether the inputted biological information corresponds to the stored biological information (Step G2).

If they do not correspond to each other in Step G2 (Step G2;NO), the process is completed. If they correspond to each other (Step G2;YES), the process proceeds to Step G3.

The controlling section 562 performing the above-mentioned control is a user identifying section for controlling an ID information transmitting section to transmit ID information only if biological information read by biological information reading section corresponds to biological information stored in a storing section of a transmitting section.

While the user A carrying the portable terminal device 506 performs those operations, he/she travels to a location where the digital copying machine 501 is installed in order to obtain a printed material which he/she himself/herself has instructed.

The portable terminal device 506 always has the wireless communication section 568 capable of receiving a busy signal (will be described later) from the digital copying machine 501. This is a busy signal receiving section for receiving a busy signal transmitted by a busy signal transmitting section, at a wireless communication section.

While the portable terminal device 506 is receiving the busy signal, the controlling section 562 judges that the digital copying machine 501 is in a busy state. When the reception of the busy signal is stopped, the controlling section 562 judges that the digital copying machine 501 is not is in a busy state.

In Step G3, the controlling section 562 judges whether the image forming device, that is, the digital copying machine 501 is currently in a busy state, and if it is not in a busy state (Step G3;NO), the controlling section 562 transmits the ID information (Step G4). In Step G4, the controlling section 562 loads ID information of the user A which in advance stored, and transmits the ID information to the digital copying machine 501 with the wireless communicating section 568. This is an ID information transmitting section for transmitting ID information which in advance stored in a storing section of a transmitting device to the image forming device with the wireless communicating section.

Further, the controlling section 562 performing the above-mentioned control is an ID information transmission stop controlling section for controlling so as to make the ID information transmitting section stop transmitting ID information while the busy signal receiving section is receiving a busy signal.

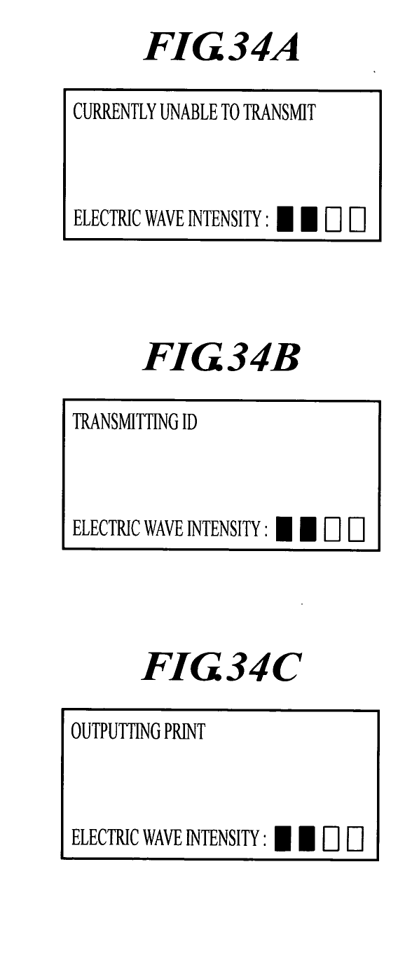

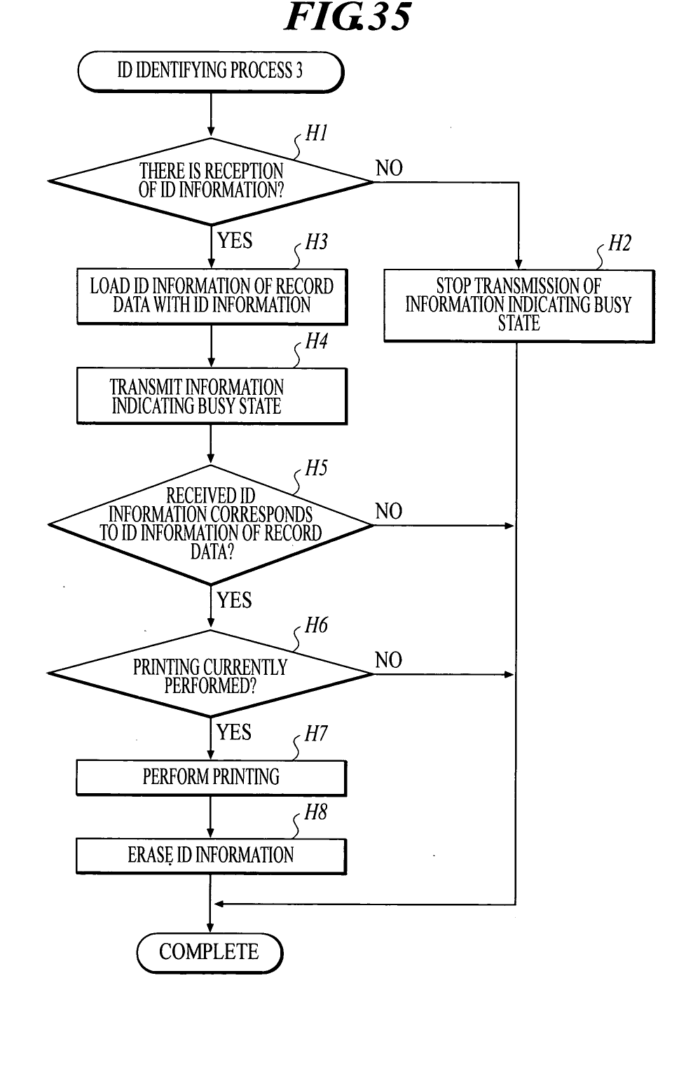

Display examples on the displaying section 565 in the above-mentioned states will be described with reference to FIGS. 34A, 34B and 34C.

FIGS. 34A, 34B and 34C are views showing examples of display contents displayed on the displaying section 565 of the portable terminal device 506 shown in FIG. 31. More concretely, FIG. 34A is a display example when the portable terminal device 506 is not able to transmit ID information because the digital copying machine 501 is in a busy state, FIG. 34B is a display example when the portable terminal device 506 is transmitting ID information to the digital copying machine 501, and FIG. 34C is a display example when the digital copying machine 501 is outputting print, that is, the digital copying machine 501 is performing the printing of the assigned record data.

Here, these displays may be performed with characters such as FIGS. 34A, 34B and 34C, or may be performed with pictorial symbols (for example, icon display). Alternatively, a structure of the displaying section 565 may be simplified, for example, so that two LEDs having locations and numbers thereof related to each meaning of FIG. 34A, FIG. 34B, FIG. 34C and the like are provided to be displayed.

By displaying a transmitting state in Step G5 of FIG. 33, it is possible to inform a user of the current state with the display of FIG. 34B or the like. After the transmission of ID information is completed, the display may proceed to FIG. 34C or the like. When a user A confirms such a display, he/she travels to the installation site of the digital copying machine 501, and when the printing is completed, he/she obtains a printed material of himself/herself outputted at the output tray 501a.

Further, with this display, it is possible to display electric wave intensity in electric wave communication between the digital copying machine 501 and the portable terminal device 506. The display of electric wave intensity may be done so as to display the intensity of electric wave that the portable terminal device 506 transmits, or it may be done so as to display the intensity of electric wave received from the digital copying machine 501.

That is a transmission state informing section for informing a user of information indicating a transmission state of ID information by the ID information transmitting section.

Here, if the digital copying machine 501 is in a busy state in Step G3 of FIG. 33 (Step G3;YES), an untransmittable state is displayed (Step G6). In Step G6, on the displaying section 565 of the portable terminal device 506, it is possible to inform a user A of a current state with the display of FIG. 34A or the like.

Further, the sound generating section 567 may output sound to a user according to each display content, a state of the digital copying machine 501 and a state of the portable terminal device 506.

Next, an operation of the digital copying machine 501 will be described.

FIG. 35 is a flowchart illustrating an ID identifying process 3 which is a process in the digital copying machine at the time of receiving record data with ID information from the personal computers 502 to 504, in the operations of the image outputting system according to the present embodiment.

The controller 512 of the digital copying machine 501 that has received record data transmitted in Step F3 of FIG. 32 through the network 505 and the network connecting section 511 determines whether the received record data is “with ID information”, and, for example, stores the record data in the storing section 515 so as to differentiate a storing area depending on whether it is “with ID information”. If the record data is not “with ID information”, as soon as the printing process currently being performed is completed, the image forming device 514 starts the printing of the record data in predetermined order. This is a with-ID-information record data receiving section for receiving record data with ID information transmitted by a with-ID-information record data transmitting section.

In such a state, the controlling section 512 of the digital copying machine 501 determines whether the digital copying machine 501 is currently receiving ID information from any one of the portable terminal devices by monitoring the wireless communication section 518 (this is an ID information receiving section for receiving ID information transmitted from an ID information transmitting section at the wireless communication section) (Step H1). Here, if ID information is not being received (Step H1;NO), by performing a process to stop the transmission of a busy signal by the wireless communication section 518, which has been being performed, transmission indicating that the digital copying machine 501 is in a busy state is stopped (Step H2).

In Step H1, if ID information is being received from any one of the portable terminal devices (Step H1;YES), the controlling section 512 loads ID information of record data with ID information received from the personal computer, the ID information being stored in the storing section 515 (Step H3). At this time, the ID information received by the wireless communication section 518 may be stored in the storing section 515.

Further, the controlling section 512 of the digital copying machine 501 starts the transmission indicating that the digital copying machine 501 is in a busy state by starting the transmission of a busy signal with the wireless communicating section 518 (Step H4). This is a busy signal transmitting section for transmitting a busy signal by the wireless communicating section at the time of receiving ID information by the ID information receiving section.

Thereafter, the controlling section 512 determines whether the ID information received in Step H1 corresponds to the ID information loaded in Step H3 (Step H5). If they do not correspond to each other at this determination (Step H5;NO), the process is completed.

If they correspond to each other at the determination in Step H5 (Step H5;YES), the controlling section 512 determines whether another printing is already being performed currently (Step H6), and if another printing is being performed (Step H6;YES), the process is completed.

At the determination in Step H6, if no other printing is being performed (Step H6;NO), the controlling section 512 loads record data with ID information stored in the storing section 515, the ID information being the ID information received in Step H1 and being added to the record data, and the image forming section 514 performs the printing based on the loaded record data (Step H7). This is a printing with ID information starting section for starting the printing by the image forming data based on record data including ID information when the ID information included in the record data with ID information received by the with-ID-information record data receiving section corresponds to the ID information received by the ID information receiving section.

A printed material in Step H7 is preferably outputted at the output tray 501a, which is a dedicated tray for record data with ID information, to be distinguished from a printed material without ID information.

Here, since this state is a state where the user A that has instructed the printing at the personal computer 502 is approaching the digital copying machine 501, by starting the printing at this point, it is possible to have the printing completed by the time that the user arrives at the digital copying machine 501, or to have little extra time to complete the printing after the user arrives at the digital copying machine 501.

Thereafter, when the printing is completed, if ID information of record data with ID information received by the network connecting section 511 and stored in the storing section 515, or ID information received by the wireless communicating section 518 and stored in the storing section 515 is remaining in the storing section 515, they are erased (Step H8) and the process is completed.

Here, in the above-mentioned embodiment, a personal computer operated by a user is to be different from each user. However, the present invention is not limited to the above-mentioned example. For example, one personal computer may be used by a plurality of users, where the personal computer identifies each user with predetermined user ID and password (or identification may be performed with biological information in the same way as the biological information reading section 566), and a storing section of the personal computer stores ID information of each of the plurality of users, and at the time of instructing the printing, ID information of each user is loaded from the storing section and added to record data to be transmitted to the digital copying machine.

Here, the description in the above-mentioned embodiment is one example of an image outputting system according to the present invention, and the present invention is not limited to the description. Detail structures and detail operations of each device composing the image outputting system may be suitably changed without departing the gist of the present invention.

The entire disclosure of Japanese Patent Applications No. Tokugan 2003-296421 filed on Aug. 20, 2003, No. Tokugan 2003-375066 filed on Nov. 5, 2003 and No. Tokugan 2004-111137 filed on Apr. 5, 2004 including specifications, claims, drawings and summaries are incorporated herein by reference in their entirety.

1. An image outputting system comprising:
a plurality of network terminals;
an image forming device for forming an image based on an image forming instruction transmitted from the plurality of network terminals, the image forming device being connected to the plurality of network terminals through a network; and
a transmitting device for wirelessly transmitting ID information thereof,
wherein the image forming device comprises:
a receiving section for receiving record data from the plurality of network terminals, the record data including record data to which ID information corresponding to the ID information of the transmitting device is added;
a storing section for storing the record data;
a wireless receiving section for wirelessly receiving the ID information from the transmitting device; and
a controlling section for controlling the image forming device to output the record data to which the ID information is added if the ID information added to the record data corresponds to the ID information received from the transmitting device.

2. The system of claim 1, wherein when the receiving section receives the record data to which ID information is not added, the controlling section controls the image forming device to sequentially output the record data to which ID information is not added.

3. The system of claim 1, wherein when the wireless receiving section receives a plurality of pieces of ID information, the controlling section controls the image forming device to stop an output of the record data to which the ID information is added and to display information indicating that the output is stopped.

4. The system of claim 1, wherein when the ID information added to the record data corresponds to the ID information received from the transmitting device and there is a job currently being outputted, the controlling section controls the image forming device to output the record data to which the ID information is added after an output of the job is completed.

5. The system of claim 1, wherein when the ID information added to the record data corresponds to the ID information received from the transmitting device and there is a job currently being outputted, the controlling section controls the image forming device to stop an output of the job, to output the record data to which the ID information is added, and to resume the output of the job after an output of the record data to which the ID information is added is completed.

6. The system of claim 1, wherein
the image forming device comprises a plurality of output trays, and
the controlling section controls the image forming device to output recording paper on which the recording data to which the ID information is added is outputted, to an output tray dedicated to the record data to which the ID information is added.

7. The system of claim 1, wherein
the transmitting device comprises an ID information transmitting instruction inputting section for inputting an ID information transmitting instruction, and
the transmitting device transmits the ID information according to an input of the ID information transmitting instruction.

8. The system of claim 7, wherein
the ID information transmitting instruction inputting section includes a biological information reading section for reading biological information from a human body, and
the ID information transmitting instruction inputting section transmits the ID information when identity is confirmed based on the biological information.

9. The system of claim 8, wherein the biological information includes fingerprint.

10. The system of claim 1 wherein the transmitting device comprises a transmitting state informing section for informing a user of information indicating a transmitting state of the ID information.

11. The system of claim 10, wherein the transmitting state informing section includes a transmitting state displaying section for displaying the information indicating the transmitting state of the ID information.

12. The system of claim 10, wherein the transmitting state informing section includes a sound generating section for informing the user of the information of the transmitting state of the ID information with sound.

13. The system of claim 1, wherein
the image forming device comprises a wireless transmitting section for wirelessly transmitting information indicating an outputting state of the record data to which the ID information is added, and
the transmitting device comprises:
an outputting state wireless receiving section for receiving the information indicating the outputting state of the record data to which the ID information is added, transmitted from the image forming device; and
an outputting state informing section for informing a user of the received information indicating the outputting state of the record data to which the ID information is added.

14. The system of claim 13, wherein the outputting state informing section includes an outputting state displaying section for displaying the information indicating the outputting state of the record data to which the ID information is added.

15. The system of claim 14, wherein the outputting state displaying section displays information indicating an outputting state of a plurality of pieces of record data to each of which the ID information is added.

16. The system of claim 13, wherein the outputting state informing section includes a sound generating section for informing the user of the information indicating the outputting state of the record data to which the ID information is added, with sound.

17. An image outputting system comprising:
at least one network terminal;
at least one image forming device comprising an image forming section for performing a printing on paper based on record data, the at least one image forming device being connected to the at least one image forming device through network;
a plurality of transmitting devices each of which is carried by each of a plurality of users who operate the at least one network terminal; and
a wireless communicating section for interconnecting wireless communication between the plurality of transmitting devices and the at least one image forming device,
wherein each of the plurality of transmitting devices comprises:
a storing section for storing ID information for identifying each of the plurality of users carrying each of the plurality of transmitting devices respectively; and
an ID information transmitting section for transmitting the ID information stored in the storing section of each the plurality of transmitting devices, to one of the at least one image forming device,
each of the at least one network terminal comprises:
a storing section in which ID information for identifying each of the plurality of users using the at least one network terminal is in advance stored; and
a with-ID-information record data transmitting section for adding the ID information stored in the storing section of each of the at least one network terminal, to the record data, and for transmitting the record data, when one of the at least one network terminal transmits the record data to be printed at the one of the at least one image forming device, to the one of the at least one image forming device,
each of the at least one image forming device comprises:
a with-ID-information record data receiving section for receiving the record data with the ID information transmitted from the with-ID-information record data transmitting section;
an ID information receiving section for receiving the ID information transmitted from the ID information transmitting section through the wireless communicating section;
a with-ID-information printing start section for making the one of the at least one image forming device start the printing, when the ID information included in the record data with ID information received by the with-ID-information record data receiving section corresponds to the ID information received by the ID information receiving section, based on the record data including the ID information; and
a busy signal transmitting section for transmitting a busy signal through the wireless communicating section while the ID information receiving section is receiving the ID information, and
each of the plurality of transmitting devices further comprises:
a busy signal receiving section for receiving the busy signal transmitted by the busy signal transmitting section, through the wireless communicating section; and
an ID information transmitting stop controlling section for controlling the ID information transmitting section to stop transmission of the ID information while the busy signal receiving section is receiving the busy signal.

18. The system of claim 17, wherein
the storing section of each of the plurality of transmitting devices stores, in advance, biological information of one user among the plurality of users, the one user corresponding to the ID information stored therein, and
each of the plurality of transmitting devices further comprise:
a biological information reading section for reading biological information inputted by each of the plurality of users; and
a user identifying section for controlling the ID information transmitting section to transmit the ID information only if the biological information read by the biological information reading section corresponds to the biological information stored in the storing section of the each of the plurality of transmitting devices.

19. The system of claim 18, wherein the biological information read by the biological information reading section includes fingerprint of the one user.

20. The system of claim 17, wherein
each of the at least one network terminal further comprises a without-ID-information record data transmitting section for transmitting only the record data without the ID information added when transmitting the record data to be printed at one of each of the at least one image forming device, to the one of the at least one the image forming device, and
each of the at least one image forming device further comprises:
a without-ID-information record data receiving section for receiving the record data transmitted by the without-ID-information record data transmitting section; and
a printing without ID information starting section for starting the printing by the image forming section based on the record data, when the without-ID-information record data receiving section receives the record data without ID information.

21. The system of claim 20, wherein each of the at least one network terminal further comprises a printing method selecting section for allowing the plurality of users to select whether to use the with-ID-information record data transmitting section or to use the without-ID-information record data transmitting section at the time of transmitting the record data to be printed at the one of the at least one image forming device, to the one of the at least one image forming device.

22. The system of claim 17, wherein each of the at least one image forming device further comprises a dedicated output tray for outputting only the paper printed by the image forming section, based on the record data with ID information received by the with-ID-information record data receiving section.

23. The system of claim 17, wherein each of the plurality of transmitting devices further comprises a transmitting state informing section for informing the plurality of users of information indicating a transmitting state of the ID information by the ID information transmitting section.
